(19) United States
(12) Patent Application Publication
(10) Pub. No.: US 2020/0292964 A1
(43) Pub. Date: Sep. 17, 2020

(54) IMAGE FORMING APPARATUS INCLUDING A TRANSPORTER HAVING BLADES AND ELECTROSTATIC IMAGE DEVELOPING TONER WITH SPECIFIED VISCOSITY

(71) Applicant: FUJI XEROX CO., LTD., Tokyo (JP)

(72) Inventors: Katsuyuki Kitajima, Kanagawa (JP); Takafumi Koide, Kanagawa (JP); Yusuke Fukuda, Kanagawa (JP); Yasuhisa Morooka, Kanagawa (JP)

(73) Assignee: FUJI XEROX CO., LTD., Tokyo (JP)

(21) Appl. No.: 16/549,417

(22) Filed: Aug. 23, 2019

(30) Foreign Application Priority Data
Mar. 14, 2019 (JP) 2019-047284

(51) Int. Cl. G03G 15/08

(52) U.S. Cl. CPC G03G 15/0891

(57) ABSTRACT

An image forming apparatus includes a developing section that includes a container containing an electrostatic charge image developer including toner and a carrier and also includes a transporter, the transporter having a rotary shaft and helical blades on the outer circumferential surface of the rotary shaft with a phase shift therebetween, the helical blades having a break zone, a zone in which the helical blades are discontinuous along the axis of the rotary shaft; a transfer section; and a fixing section. The toner satisfies the following relations: (ln η(T1)−ln η(T2))/(T1−T2)≤−0.14; (ln η(T2)−ln η(T3))/(T2−T3)≥−0.15; and (ln η(T1)−ln η(T2))/(T1−T2)<(ln η(T2)−ln η(T3))/(T2−T3), where η(T1) represents the viscosity of the toner at 60° C., η(T2) represents the viscosity of the toner at 90° C., and η(T3) represents the viscosity of the toner at 130° C.

### CROSS-REFERENCE TO RELATED APPLICATIONS

This application is based on and claims priority under 35 USC 119 from Japanese Patent Application No. 2019-047284 filed Mar. 14, 2019.

### BACKGROUND

### (i) Technical Field

The present disclosure relates to an image forming apparatus.

### (ii) Related Art

Nowadays electrophotography and other methods of visualizing image information via an electrostatic charge image are used in various fields.

In the related art, electrophotography visualizes image information typically through the multiple operations of forming an electrostatic charge image on a photoreceptor or electrostatic recording medium by any of various techniques, developing the electrostatic latent image (toner image) by attaching electrosensitive particles called toner to the electrostatic latent image, transferring the toner image to the surface of a substrate, and fixing the transferred image, for example by heating.

Japanese Unexamined Patent Application Publication No. 11-194542 discloses an electrophotographic toner that includes a binder resin and a coloring agent. The binder resin has its minimum tan δ at a temperature between its glass transition temperature (Tg) and the temperature at which its loss modulus (G″)=1×10⁴ Pa. The minimum tan δ is less than 1.2, and at the temperature at which the tan δ is at its minimum, the resin has a storage modulus (G′)=5×10⁵ Pa or more. At the temperature at which G″=1×10⁴ Pa, the tan δ is 3.0 or more.

Japanese Unexamined Patent Application Publication No. 2010-256429 discloses an agitator-transporter for a developer. The agitator-transporter includes a multi-start auger and a break portion. The multi-start auger has a common rotary shaft and multiple helical blades wound around the rotary shaft, and the break portion divides the multi-start auger to make it discontinuous in the axial direction. In the break portion, there is a phase shift between the upstream and downstream ends of the multi-start auger with regard to circumferential positions on the rotary shaft.

The developing section of an image forming apparatus of the related art has a transporter. The transporter supplies a developer to a developing member while agitating and mixing toner for developing an electrostatic charge image (hereinafter also referred to simply as “toner”) with a carrier. In practical use, the transporter may have multiple blades so that the toner and carrier can be agitated better (this type of transporter is called a phase-shift auger). Improved agitating of the toner and carrier will reduce fog on the image by narrowing the distribution of charge in the toner.

If the toner is low in viscoelasticity, however, the use of a phase-shift auger (hereinafter also referred to as a “PS auger”) may result in external additives contained in the toner becoming embedded in toner particles because of the strong agitating force of the auger. The external additives embedded in toner particles will cause the toner to aggregate more easily, thereby making it more likely that lumps of the toner formed in the developing section are transferred to the image area or non-image area of the image carrier and carry over to the finished image as blots (so-called leaking toner). Leaking toner tends to be frequent particularly when an image with a low area coverage (e.g., a toner density of 4.5 g/m²) is formed under high-temperature and high-humidity conditions (e.g., 30° C. and 90% RH). In such a situation, little toner flows through the developing section because of the low area coverage, and the toner easily softens because of the high temperature. The embedment of external additives in toner particles is therefore promoted, and the aggregation of the toner becomes even more likely, making leaking toner frequent.

Increasing the viscoelasticity of the toner, however, causes the toner to break or chip more easily. The pieces of broken toner or toner chips can scatter, and the scattered pieces of toner can form color spots on the finished image by being transferred to the image area or non-image area of the image carrier. Color spots tend to be frequent particularly when an image with a low area coverage (e.g., a toner density of 4.5 g/m²) is formed under low-temperature and low-humidity conditions (e.g., 10° C. and 15% RH). In such a situation, little toner flows through the developing section because of the low area coverage, and therefore the toner tends to be exposed to stress continuously in the developing section. Moreover, the toner easily hardens because of the low temperature. Toner breaking and chipping are therefore even more likely, making color spots frequent.

### SUMMARY

Aspects of non-limiting embodiments of the present disclosure relate to image forming apparatuses that use a rotary container for replenishment toner and provide an image forming apparatus that reduces leaking toner, color spots, and fog on the image in comparison with when the toner has a (ln η(T1)−ln η(T2))/(T1−T2) exceeding −0.14 or a (ln η(T2)−ln η(T3))/(T2−T3) of less than −0.15.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image carrier; a charging section that charges the surface of the image carrier; an electrostatic charge image forming section that forms an electrostatic charge image on the charged surface of the image carrier; a developing section that includes a container containing an electrostatic charge image developer and also includes a transporter for the electrostatic charge image developer, the electrostatic charge image developer including toner and a carrier, the transporter having a rotary shaft and multiple helical blades on the outer circumferential surface of the rotary shaft with a phase shift therebetween, the helical blades having a break zone, a zone in which the helical blades are discontinuous along the axis of the rotary shaft; a transfer section that transfers the toner image formed on the surface of the image carrier to a substrate; and a fixing section that fixes the toner image transferred to the substrate.

The toner satisfies the following relations:

(ln η(T1)−ln η(T2))/(T1−T2)≤−0.14;

(ln η(T2)−ln η(T3))/(T2−T3)≥−0.15; and

(ln η(T1)−ln η(T2))/(T1−T2)<(ln η(T2)−ln η(T3))/(T2−T3),

where η(T1) represents the viscosity of the toner at 60° C., η(T2) represents the viscosity of the toner at 90° C., and η(T3) represents the viscosity of the toner at 130° C.

### BRIEF DESCRIPTION OF THE DRAWINGS

Exemplary embodiments of the present disclosure will be described in detail based on the following figures, wherein:

FIG. 1 schematically illustrates the structure of an image forming apparatus according to an exemplary embodiment;

FIG. 2 schematically illustrates the structure of a process cartridge according to an exemplary embodiment;

FIG. 3 is a schematic cross-sectional side view of a developing section used in an exemplary embodiment;

FIG. 4 is a schematic cross-sectional plan view of a developing section used in an exemplary embodiment;

FIG. 5 schematically illustrates an admix auger as part of a developing section used in a first exemplary embodiment;

FIG. 6A schematically illustrates the direction of rotation and angular regions of the admix auger as part of a developing section used in the first exemplary embodiment, and FIG. 6B schematically illustrates the angular regions in which the auger's helical blades are present versus the position along the axis;

FIG. 7 is a schematic diagram for describing how a break portion works in the admix auger as part of a developing section used in the first exemplary embodiment; and

FIG. 8 schematically illustrates an admix auger as part of a developing section used in a second exemplary embodiment.

### DETAILED DESCRIPTION

If a composition described herein contains a combination of multiple substances as an ingredient, the amount of the ingredient represents the total amount of the substances in the composition unless stated otherwise.

“A toner for electrostatic-charge-image development” herein may be referred to simply as “a toner.” “An electrostatic charge image developer” herein may be referred to simply as “a developer.”

The following describes an exemplary embodiment as an example of the present disclosure.

An image forming apparatus according to this exemplary embodiment includes an image carrier; a charging section that charges the surface of the image carrier; an electrostatic charge image forming section that forms an electrostatic charge image on the charged surface of the image carrier; a developing section that includes a container containing an electrostatic charge image developer and also includes a transporter for the electrostatic charge image developer, the electrostatic charge image developer including toner for electrostatic-charge-image development and a carrier, the transporter having a rotary shaft and multiple helical blades on the outer circumferential surface of the rotary shaft with a phase shift therebetween, the helical blades having a break zone, a zone in which the helical blades are discontinuous along the axis of the rotary shaft; a transfer section that transfers the toner image formed on the surface of the image carrier to a substrate; and a fixing section that fixes the toner image transferred to the substrate. The toner satisfies the following relations:

(ln η(T1)−ln η(T2))/(T1−T2)≤−0.14;

(ln η(T2)−ln η(T3))/(T2−T3)≥−0.15; and

(ln η(T1)−ln η(T2))/(T1−T2)<(ln η(T2)−ln η(T3))/(T2−T3),

where η(T1) represents the viscosity of the toner at 60° C., η(T2) represents the viscosity of the toner at 90° C., and η(T3) represents the viscosity of the toner at 130° C. A toner having these characteristics may hereinafter be referred to simply as a “specific toner.”

Configured as above, an image forming apparatus according to this exemplary embodiment has improved leaking toner, color spots, and fog on the finished image.

The reason for this is unclear, but the inventors speculate as follows.

First, the characteristics of a specific toner used in this exemplary embodiment are described. The formula (ln η(T1)−ln η(T2))/(T1−T2) is a measure of how much the viscosity of the toner changes at temperatures from 60° C. to 90° C., and a (ln η(T1)−ln η(T2))/(T1−T2) of −0.14 or less means that the toner greatly changes its viscosity at temperatures from 60° C. to 90° C. The formula (ln η(T2)−ln η(T3))/(T2−T3), on the other hand, is a measure of how much the viscosity of the toner changes at temperatures from 90° C. to 120° C., and a (ln η(T2)−ln η(T3))/(T2−T3) of −0.15 or more and greater than the (1nη(T1)−ln η(T2))/(T1−T2) means that the toner changes little its viscosity at temperatures from 90° C. to 120° C. The specific toner therefore changes its viscosity sharply at temperatures from 60° C. to 90° C. and little at temperatures from 90° C. to 120° C.

In a toner that exhibits such a viscosity profile, the inventors believe, the binder resin contained in the toner particles has low-molecular-weight and high-molecular-weight components both in appropriate proportions. That is, a low-molecular-weight component in the binder resin promotes changes in viscosity at temperatures from 60° C. to 90° C., whereas a high-molecular-weight component in the binder resin limits changes in viscosity at high temperatures from 90° C. to 120° C.

By the characteristic of such a viscosity profile, the specific toner changes little its viscosity and has moderate viscoelasticity at temperatures from room temperature (e.g., 20° C.) to 60° C. That is, the presence of appropriate proportions of low- and high-molecular-weight components in the binder resin ensures that the specific toner is stable in viscosity and maintains moderate viscoelasticity at temperatures of 60° C. or below. The specific toner, having the characteristics specified above, is therefore stable in viscosity and has moderate viscoelasticity at temperatures from room temperature to 60° C.

As mentioned above, image forming apparatuses of the related art have used a transporter having multiple agitating blades (i.e., a PS auger) for better agitating of toner and a carrier, and it works well in reducing fog on the image. If the toner is low in viscoelasticity, however, the use of a PS auger may result in leaking toner on the finished image because agitating with the PS auger can cause external additives in the toner to become embedded in toner particles. Increasing the viscoelasticity of the toner, however, causes the toner to break or chip more easily. The pieces of broken toner or toner chips can form color spots on the finished image.

This exemplary embodiment uses a transporter as described above (i.e., a PS auger) to reduce fog on the image. Besides that, this exemplary embodiment uses a specific toner, which has the characteristics specified above. The toner is therefore moderate in viscoelasticity. Therefore, the inventors believe, the embedment of external additives in toner particles, which occurs if the toner has too low viscoelasticity, is reduced, and leaking toner on the finished image is therefore less frequent. Toner breaking and chipping, which occur if the toner has too high viscoelasticity, are also reduced, and color spots on the finished image are therefore less frequent. The inventors believe this exemplary embodiment therefore helps achieve consistency in image quality.

Next is described each section, element, etc., making up an image forming apparatus according to this exemplary embodiment in detail.

### Electrostatic Charge Image Developer

First, the electrostatic charge image developer contained in the developing section of an image forming apparatus according to this exemplary embodiment is described.

An electrostatic charge image developer according to this exemplary embodiment includes at least a specific toner. The electrostatic charge image developer is a two-component developer, which includes a specific toner and a carrier.

### Toner for Electrostatic-Charge-Image Development

The following describes a specific toner used in this exemplary embodiment in detail.

A specific toner contains toner particles and external additives.

### Temperature and Viscosity Parameters of the Toner

The Specific Toner Satisfies the Following Relations:

(ln η(T1)−ln η(T2))/(T1−T2)≤−0.14;

(ln η(T2)−ln η(T3))/(T2−T3)≤−0.15; and

(ln η(T1)−ln η(T2))/(T1−T2)<(ln η(T2)−ln η(T3))/(T2−T3),

where η(T1) represents the viscosity of the specific toner at 60° C., η(T2) represents the viscosity of the specific toner at 90° C., and η(T3) represents the viscosity of the specific toner at 130° C.

The expression “ln η(T1)” herein represents the natural logarithm of the viscosity η of the toner at T1=60° C. It may be expressed as ln(η(T1)).

Viscosity values of a toner herein have a unit of Pa·s unless stated otherwise.

These viscosity values at certain temperatures of a toner in this exemplary embodiment are measurements obtained as follows.

Viscosity values of a toner in this exemplary embodiment are determined by performing a temperature elevation test using a plate rheometer (Rheometrics RDA2, RHIOS system ver. 4.3). In the test, an approximately 0.3-g sample of the toner placed between 8-mm parallel plates is heated from approximately 30° C. to approximately 150° C. at a temperature elevation rate of 1° C./min under a 20% or less distortion at a frequency of 1 Hz.

The (ln η(T1)−ln η(T2))/(T1−T2) as a parameter of the specific toner is −0.14 or less. It may be −0.16 or less, preferably −0.30 or more and −0.18 or less, more preferably −0.25 or more and −0.20 or less in view of the reduction of leaking toner, color spots, and fog on the finished image.

The (ln η(T2)−ln η(T3))/(T2−T3) as a parameter of the specific toner is −0.15 or more. It may be more than −0.14, preferably −0.13 or more, more preferably −0.12 or more and −0.03 or less, in particular −0.11 or more and −0.05 or less in view of the reduction of leaking toner, color spots, and fog on the finished image.

Moreover, the (ln η(T2)−ln η(T3))/(T2−T3) of the specific toner is larger than the (ln η(T1)−ln η(T2))/(T1−T2) of the specific toner. The {(ln η(T2)−ln η(T3))/(T2−T3)}−{(ln η(T1)−ln η(T2))/(T1−T2)} may be 0.01 or more, preferably 0.05 or more and 0.5 or less, in particular 0.08 or more and 0.2 or less in view of the reduction of leaking toner, color spots, and fog on the finished image.

The specific toner, moreover, may have a (ln η(T0)−ln η(T1))/(T0−T1), where η(T0) represents the viscosity η of the toner at T0=40° C., of −0.12 or more and greater than the (ln η(T1)−ln η(T2))/(T1−T2).

The specific toner becomes more effective in reducing leaking toner, color spots, and fog on the finished image and therefore in achieving consistency in image quality when it has a (ln η(T0)−ln η(T1))/(T0−T1) of −0.12 or more. The (ln η(T0)−ln η(T1))/(T0−T1) may be −0.05 or less, in particular −0.11 or more and −0.06 or less.

The specific toner, moreover, becomes more effective in reducing leaking toner, color spots, and fog on the finished image and therefore in achieving consistency in image quality when its (ln η(T0)−ln η(T1))/(T0−T1) is greater than its (ln η(T1)−ln η(T2))/(T1−T2). The {(ln η(T0)−ln η(T1))/(T0−T1)}−{(ln η(T1)−ln η(T2))/(T1−T2)} may be 0.01 or more, preferably 0.05 or more and 0.5 or less, in particular 0.08 or more and 0.2 or less.

It should be noted that these temperature and viscosity parameters ln η(T1)−ln η(T2))/(T1−T2), (ln η(T2)−ln η(T3))/(T2−T3), and (ln η(T0)−ln η(T1))/(T0−T1) of the toner may be controlled to be within the above ranges by any method. An example is to adjust the molecular weight of the binder resin in the toner particles, more specifically the molecular weights and percentages of the low-molecular-weight and high-molecular-weight components of the binder resin. If the toner particles are produced by the undermentioned aggregation and coalescence approach, these parameters may alternatively be controlled by adjusting the degree of aggregation, for example by changing the amount of flocculant.

The η(T0), η(T1), η(T2), and η(T3) of the specific toner, which are the viscosity values of the toner at T0=40° C., T1=60° C., T2=90° C., and T3=130° C., respectively, may be respectively within the following ranges in view of the reduction of leaking toner, color spots, and fog on the finished image.

η(T0): 1.0×10⁷ or more and 1.0×10⁹ or less (preferably 2.0×10⁷ or more and 5.0×10⁸ or less)

η(T1): 1.0×10⁵ or more and 1.0×10⁸ or less (preferably 1.0×10⁶ or more and 5.0×10⁷ or less)

η(T2): 1.0×10³ or more and 1.0×10⁵ or less (preferably 5.0×10³ or more and 5.0×10⁴ or less)

η(T3): 1.0×10² or more and 1.0×10⁴ or less (preferably 1.0×10² or more and 5.0×10³ or less)

### Highest-Endothermic-Peak Temperature of the Toner

The highest-endothermic-peak temperature of the specific toner may be 70° C. or more and 100° C. or less, preferably 75° C. or more and 95° C. or less, in particular 83° C. or more and 93° C. or less.

Here, the highest-endothermic-peak temperature of a specific toner is defined as the temperature at which the toner's differential scanning calorimetry (DSC) endothermic curve measured over the range of at least −30° C. to 150° C. has its highest peak.

A method that may be used to measure the highest-endothermic-peak temperature of a specific toner is as follows.

The measuring instrument is PerkinElmer DSC-7 differential scanning calorimeter. The temperature calibration of the colorimeter's detector is based on the melting point of indium and zinc, and the enthalpy calibration is based on the melting enthalpy of indium. An aluminum pan with a sample therein and a control empty pan are heated from room temperature to 150° C. at a temperature elevation rate of 10° C./min, cooled from 150° C. to −30° C. at a rate of 10° C./min, and then heated from −30° C. to 150° C. at a rate of 10° C./min. The temperature at which the largest endothermic peak is observed in the second run of heating is the highest-endothermic-peak temperature.

### Infrared Absorption Spectrum of the Toner Particles

If the specific toner contains the undermentioned amorphous polyester resin as a binder resin, it may be that in an infrared absorption (IR) spectrum of the toner particles, the ratio of the absorbance at a wavenumber of 1,500 cm⁻¹ to that at 720 cm⁻¹ (absorbance at 1,500 cm⁻¹/absorbance at 720 cm⁻¹) is 0.6 or less, and, at the same time, the ratio of the absorbance at a wavenumber of 820 cm⁻¹ to that at 720 cm⁻¹ (absorbance at 820 cm⁻¹/absorbance at 720 cm⁻¹) is 0.4 or less in view of the reduction of leaking toner, color spots, and fog on the finished image.

Preferably, in an IR spectrum of the toner particles, the ratio of the absorbance at a wavenumber of 1,500 cm⁻¹ to that at 720 cm⁻¹ is 0.4 or less with the ratio of the absorbance at a wavenumber of 820 cm⁻¹ to that at 720 cm⁻¹ being 0.2 or less. It is more preferred that in an IR spectrum of the toner particles, the ratio of the absorbance at a wavenumber of 1,500 cm⁻¹ to that at 720 cm⁻¹ be 0.2 or more and 0.4 or less with the ratio of the absorbance at a wavenumber of 820 cm⁻¹ to that at 720 cm being 0.05 or more and 0.2 or less.

These IR absorbance values at certain wavenumbers in this exemplary embodiment are measured as follows. First, the toner particles of interest (after the removal of any external additive from the toner) are made into a sample for measurement by KBr tableting. This sample for measurement is analyzed using an IR spectrophotometer (JASCO FT-IR-410) at wavenumbers between 500 cm⁻¹ and 4,000 cm⁻¹ under the conditions of 300 scans and a resolution of 4 cm⁻¹. Then baseline correction is performed, for example in an offset, a spectral portion with no absorption, to determine the absorbance values at the wavenumbers.

The specific toner, moreover, may be such that in an IR spectrum of the toner particles, the ratio of the absorbance at a wavenumber of 1,500 cm⁻¹ to that at 720 cm⁻¹ may be 0.6 or less, preferably 0.4 or less, more preferably 0.2 or more and 0.4 or less, in particular 0.3 or more and 0.4 or less in view of the reduction of leaking toner, color spots, and fog on the finished image.

Likewise, the specific toner may be such that in an IR spectrum of the toner particles, the ratio of the absorbance at a wavenumber of 820 cm⁻¹ to that at 720 cm⁻¹ may be 0.4 or less, preferably 0.2 or less, more preferably 0.05 or more and 0.2 or less, in particular 0.08 or more and 0.2 or less in view of the reduction of leaking toner, color spots, and fog on the finished image.

### Toner Particles

The toner particles contain, for example, a binder resin and optionally a coloring agent, a release agent, and/or other additives. Preferably, the toner particles contain a binder resin and a release agent.

In this exemplary embodiment, the toner particles may be of any kind. Examples include particles such as of a yellow, magenta, cyan, or black toner and even include white toner particles, transparent toner particles, and glossy toner particles.

### Binder Resin

The binder resin may be, for example, a vinyl resin. The vinyl resin may be a homopolymer of a monomer or a copolymer of two or more monomers, and examples of monomers include styrenes (e.g., styrene, p-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenic unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene).

Alternatively, the binder resin may be, for example, a non-vinyl resin, such as an epoxy resin, polyester resin, polyurethane resin, polyamide resin, cellulose resin, polyether resin, or modified rosin, a mixture of any of these resins and the aforementioned vinyl resin, or a graft copolymer obtained by copolymerizing a vinyl monomer in the presence of any of these non-vinyl resins.

One of these binder resins may be used alone, or two or more may be used in combination.

The binder resin(s) may include at least one selected from the group consisting of a styrene-acrylic resin and an amorphous polyester resin, preferably one of a styrene-acrylic resin and an amorphous polyester resin, in view of the reduction of leaking toner, color spots, and fog on the finished image. It is more preferred that the percentage of the styrene-acrylic resin or amorphous polyester resin to the total mass of binder resins in the toner be 50% by mass or more, in particular 80% by mass or more.

A styrene-acrylic resin gives the specific toner strength and stability during storage if contained as a binder resin.

An amorphous polyester resin ensures fixation at low temperatures if contained in the specific toner as a binder resin.

The amorphous polyester resin may be one that has no bisphenol structure in view of the reduction of leaking toner, color spots, and fog on the finished image and also of fixation.

### (1) Styrene-Acrylic Resin

An example of a binder resin is a styrene-acrylic resin.

A styrene-acrylic resin is a copolymer of at least a styrene monomer (monomer having the styrene structure) and a (meth)acrylic monomer (monomer having a (meth)acrylic group, preferably a (meth)acryloxy group). Copolymers of, for example, a styrene monomer and any of the aforementioned (meth)acrylate monomers are also examples of styrene-acrylic resins.

It is to be noted that the acrylic resin segment of a styrene-acrylic resin is a moiety resulting from the polymerization of an acrylic monomer, a methacrylic monomer, or both. The expression “(meth)acrylic” is intended to represent both “acrylic” and “methacrylic.”

Specific examples of styrene monomers include styrene, alkylated styrenes (e.g., α-methylstyrene, 2-methylstyrene, 3-methylstyrene, 4-methylstyrene, 2-ethylstyrene, 3-ethylstyrene, and 4-ethylstyrene), halogenated styrenes (e.g., 2-chlorostyrene, 3-chlorostyrene, and 4-chlorostyrene), and vinylnaphthalene. One styrene monomer may be used alone, or two or more may be used in combination.

Of these styrene monomers, styrene is preferred for its high reactivity, ready availability, and ease of control of the reaction involving it.

Specific examples of (meth)acrylic monomers include (meth)acrylic acid and (meth)acrylates. Examples of (meth)acrylates include alkyl (meth)acrylates (e.g., methyl (meth)acrylate, ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (e.g., phenyl (meth)acrylate, biphenyl (meth)acrylate, diphenylethyl (meth) acrylate, t-butylphenyl (meth) acrylate, and terphenyl (meth)acrylate), dimethylaminoethyl (meth) acrylate, diethylaminoethyl (meth) acrylate, methoxyethyl (meth)acrylate, 2-hydroxyethyl (meth)acrylate, β-carboxyethyl (meth)acrylate, and (meth)acrylamides. One (meth)acrylic monomer may be used alone, or two or more may be used in combination.

Of these (meth)acrylates as (meth)acrylic monomers, those (meth)acrylates that have a C2-14 (preferably C2-10, more preferably C3-8) alkyl group are preferred because they provide better fixation of the toner.

n-Butyl (meth)acrylate is particularly preferred. In particular, n-butyl acrylate is preferred.

The copolymer may contain styrene monomers and (meth)acrylic monomers in any ratio (by mass, styrene monomers/(meth)acrylic monomers). For example, the ratio of the two types of monomers in the copolymer may be between 85/15 to 70/30.

The styrene-acrylic resin may have a crosslink structure in view of the reduction of leaking toner, color spots, and fog on the finished image. An example of a crosslinked styrene-acrylic resin is a copolymer of at least a styrene monomer, a (meth)acrylic monomer, and a crosslinking monomer.

The crosslinking monomer may be, for example, a crosslinking agent that has two or more functional groups.

Examples of bifunctional crosslinking agents include divinyl benzene, divinyl naphthalene, di(meth)acrylate compounds (e.g., diethylene glycol di(meth)acrylate, methylene bis(meth)acrylamide, decanediol diacrylate, and glycidyl (meth)acrylate), polyester-forming di(meth)acrylates, and 2-([1′-methylpropylideneamino]carboxyamino)ethyl methacrylate.

Examples of multifunctional crosslinking agents include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., pentaerythritol tetra(meth)acrylate and oligoester (meth)acrylates), 2,2-bis(4-methacryloxy, polyethoxyphenyl)propane, diallyl phthalate, triallyl cyanurate, triallyl isocyanurate, triallyl trimellitate, and diaryl chlorendate.

Preferably, the crosslinking monomer is a (meth)acrylate compound that has two or more functional groups in view of the reduction of leaking toner, color spots, and fog on the finished image. It is more preferred that the crosslinking agent be a bifunctional (meth)acrylate compound, even more preferably a bifunctional (meth)acrylate that has a C6-20 alkylene group, in particular a bifunctional (meth)acrylate that has a linear C6-20 alkylene group.

The copolymer may contain crosslinking monomers in any ratio to all monomers (by mass, crosslinking monomers/all monomers). For example, the ratio of crosslinking monomers to all monomers may be between 2/1,000 and 20/1,000.

The glass transition temperature (Tg) of the styrene-acrylic resin may be 40° C. or more and 75° C. or less, preferably 50° C. or more and 65° C. or less, in view of fixation.

This glass transition temperature is that determined from the resin's DSC curve, which is obtained by differential scanning calorimetry (DSC). More specifically, this glass transition temperature is the resin's “extrapolated initial temperature of glass transition” as in the methods for determining glass transition temperatures set forth in JIS K 7121-1987 “Testing Methods for Transition Temperatures of Plastics.”

The weight-average molecular weight of the styrene-acrylic resin may be 5,000 or more and 200,000 or less, preferably 10,000 or more and 100,000 or less, in particular 20,000 or more and 80,000 or less, in view of stability during storage.

The production of the styrene-acrylic resin may be by any method. A wide variety of polymerization techniques (solution polymerization, precipitation polymerization, suspension polymerization, bulk polymerization, emulsion polymerization, etc.) may be used, and the polymerization reactions may be done by any process (batch, semicontinuous, continuous, etc.).

### (2) Polyester Resin

A polyester resin is also an example of a binder resin. The polyester resin may be, for example, a known amorphous polyester resin. It is also possible to use a crystalline polyester resin in combination with an amorphous polyester resin. In that case, the amount of the crystalline polyester resin may be, for example, 2% by mass or more and 40% by mass or less (preferably 2% by mass or more and 20% by mass or less) with respect to all binder resins.

If a resin is “crystalline” herein, it means that the resin exhibits not stepwise changes in heat absorption but a clear endothermic peak when analyzed by differential scanning calorimetry (DSC). To be more specific, being “crystalline” herein means that the half width of the endothermic peak as measured at a temperature elevation rate of 10 (° C./min) is 10° C. or narrower.

Meanwhile, if a resin is “amorphous” herein, it means that in DSC, the above half width is broader than 10° C., the resin exhibits stepwise changes in heat absorption, or the endothermic peak is not clear.

### Amorphous Polyester Resin

The amorphous polyester resin may be, for example, a polycondensate of a polycarboxylic acid and a polyhydric alcohol. The amorphous polyester resin may be a commercially available one or may be a synthesized one.

Examples of polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), and anhydrides or lower-alkyl (e.g., C1-5 alkyl) esters of these acids. Of these polycarboxylic acids, aromatic dicarboxylic acids, for example, are preferred.

For polycarboxylic acids, it is also possible to use a dicarboxylic acid in combination with a crosslinked or branched carboxylic acid that has three or more carboxylic groups. Examples of carboxylic acids that have three or more carboxylic groups include trimellitic acid, pyromellitic acid, and anhydrides or lower-alkyl (e.g., C1-5 alkyl) esters of these acids.

One polycarboxylic acid may be used alone, or two or more may be used in combination.

Examples of polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these polyhydric alcohols, aromatic diols and alicyclic diols, for example, are preferred, and aromatic diols are more preferred.

For polyhydric alcohols, it is also possible to use a diol in combination with a crosslinked or branched polyhydric alcohol that has three or more hydroxyl groups. Examples of polyhydric alcohols that have three or more hydroxyl groups include glycerol, trimethylolpropane, and pentaerythritol.

One polyhydric alcohol may be used alone, or two or more may be used in combination.

The glass transition temperature (Tg) of the amorphous polyester resin may be 50° C. or more and 80° C. or less, preferably 50° C. or more and 65° C. or less.

This glass transition temperature is that determined from the resin's DSC curve, which is obtained by differential scanning calorimetry (DSC). More specifically, this glass transition temperature is the resin's “extrapolated initial temperature of glass transition” as in the methods for determining glass transition temperatures set forth in JIS K 7121-1987 “Testing Methods for Transition Temperatures of Plastics.”

The weight-average molecular weight (Mw) of the amorphous polyester resin may be 5000 or more and 1000000 or less, preferably 7000 or more and 500000 or less.

The number-average molecular weight (Mn) of the amorphous polyester resin may be 2000 or more and 100000 or less.

The molecular weight distribution Mw/Mn of the amorphous polyester resin may be 1.5 or more and 100 or less, preferably 2 or more and 60 or less.

These weight- and number-average molecular weights are those measured by gel permeation chromatography (GPC). By GPC, the resin is analyzed using HLC-8120GPC, a GPC system from Tosoh, and Tosoh TSKgel SuperHM-M column (15 cm) with the eluate tetrahydrofuran (THF). Comparing the measured data with a molecular-weight calibration curve prepared using monodisperse polystyrene standards gives the weight- and number-average molecular weights.

The production of the amorphous polyester resin may be by a known method. To be more specific, the amorphous polyester resin may be obtained by, for example, polymerizing starting monomers by condensation polymerization at a temperature of 180° C. or more and 230° C. or less, optionally under reduced pressure so that the water and alcohol as condensation by-products will be removed.

If the starting monomers do not dissolve or are not compatible with each other at the reaction temperature, a high-boiling-point solvent as a solubilizer may be added to help them dissolve. In that case, the solubilizer is removed by distillation during the polycondensation. If the copolymerization involves a monomer that is incompatible with the reaction system, this monomer may be first condensed with an acid or alcohol planned to participate in the polycondensation and then subjected to polycondensation with the remaining ingredient(s).

Crystalline Polyester Resin

The crystalline polyester resin may be, for example, a polycondensate of a polycarboxylic acid and a polyhydric alcohol. The crystalline polyester resin may be a commercially available one or may be a synthesized one.

The crystalline polyester resin may be a polycondensate made using polymerizable monomers having a linear aliphatic structure, rather than an aromatic structure. This helps the resin form its crystal structure.

Examples of polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids, such as phthalic acid, isophthalic acid, terephthalic acid, and naphthalene-2,6-dicarboxylic acid), and anhydrides or lower-alkyl (e.g., C1-5 alkyl) esters of these acids.

For polycarboxylic acids, it is also possible to use a dicarboxylic acid in combination with a crosslinked or branched carboxylic acid that has three or more carboxylic groups. Examples of carboxylic acids that have three or more carboxylic groups include aromatic carboxylic acids (e.g., 1,2,3-benzenetricarboxylic acid, 1,2,4-benzenetricarboxylic acid, and 1,2,4-naphthalenetricarboxylic acid) and anhydrides or lower-alkyl (e.g., C1-5 alkyl) esters of these acids.

Moreover, it is possible to use any of the above carboxylic acids with a dicarboxylic acid that has a sulfonic acid group and/or a dicarboxylic acid that has an ethylenic double bond.

One polycarboxylic acid may be used alone, or two or more may be used in combination.

Examples of polyhydric alcohols include aliphatic diols (e.g., C7-20 linear aliphatic diols). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these aliphatic diols, 1,8-octanediol, 1,9-nonanediol, and 1,10-decanediol are preferred.

For polyhydric alcohols, it is also possible to use a diol in combination with a crosslinked or branched alcohol that has three or more hydroxyl groups. Examples of alcohols that have three or more hydroxyl groups include glycerol, trimethylolethane, trimethylolpropane, and pentaerythritol.

One polyhydric alcohol may be used alone, or two or more may be used in combination.

For polyhydric alcohols, the percentage of aliphatic diols may be 80 mol % or more, preferably 90 mol % or more.

The melting temperature of the crystalline polyester resin may be 50° C. or more and 100° C. or less, preferably 55° C. or more and 90° C. or less, more preferably 60° C. or more and 85° C. or less.

This melting temperature is the resin's “peak melting temperature” as in the methods for determining melting temperatures set forth in JIS K7121-1987 “Testing Methods for Transition Temperatures of Plastics” and is determined from the resin's DSC curve, which is obtained by differential scanning calorimetry (DSC).

The weight-average molecular weight (Mw) of the crystalline polyester resin may be 6,000 or more and 35,000 or less.

The production of the crystalline polyester resin may be by a known method. For example, the crystalline polyester resin may be produced in the same way as the amorphous polyester resin.

The amount of the binder resin(s) may be, for example, 40% by mass or more and 95% by mass or less, preferably 50% by mass or more and 90% by mass or less, more preferably 60% by mass or more and 85% by mass or less of the total mass of the toner particles.

If the toner particles are white toner particles, the percentage of the binder resin(s) may be 30% by mass or more and 85% by mass or less, preferably 40% by mass or more and 60% by mass or less of the total mass of the white toner particles.

### Coloring Agent

Examples of coloring agents include pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, malachite green oxalate, titanium oxide, zinc oxide, calcium carbonate, basic lead carbonate, a zinc sulfide-barium sulfate mixture, zinc sulfide, silicon dioxide, and aluminum oxide, and dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes.

If the toner particles are white toner particles, the coloring agent is a white pigment.

The white pigment may be titanium oxide or zinc oxide, preferably titanium oxide.

One coloring agent may be used alone, or two or more may be used in combination.

The coloring agent(s) may optionally be surface-treated one(s) and may be used in combination with a dispersant. Moreover, multiple coloring agents may be used in combination.

The amount of the coloring agent(s) may be 1% by mass or more and 30% by mass or less, preferably 3% by mass or more and 15% by mass or less of the total mass of the toner particles.

If the toner particles are white toner particles, the amount of the white pigment(s) may be 15% by mass or more and 70% by mass or less, preferably 20% by mass or more and 60% by mass or less, of the total mass of the white toner particles.

### Release Agent

Examples of release agents include, but are not limited to, hydrocarbon waxes; natural waxes, such as carnauba wax, rice wax, and candelilla wax; synthesized or mineral/petroleum waxes, such as montan wax; and ester waxes, such as fatty acid esters and montanates.

The melting temperature of the release agent may be 50° C. or more and 110° C. or less, preferably 70° C. or more and 100° C. or less, more preferably 75° C. or more and 95° C. or less, in particular 83° C. or more and 93° C. or less, in view of the reduction of leaking toner, color spots, and fog on the finished image.

This melting temperature is the agent's “peak melting temperature” as in the methods for determining melting temperatures set forth in JIS K 7121-1987 “Testing Methods for Transition Temperatures of Plastics” and is determined from the agent's DSC curve, which is obtained by differential scanning calorimetry (DSC).

The toner particles in the specific toner may satisfy the relation 1.0<a/b<8.0, where a and b are the numbers of the release agent with an aspect ratio of 5 or more and smaller than 5, respectively, in the toner particles, in view of the reduction of leaking toner, color spots, and fog on the finished image. Preferably, the toner particles satisfy the relation 2.0<a/b<7.0, in particular 3.0<a/b<6.0.

The toner particles in the specific toner, moreover, may satisfy the relation 1.0<c/d<4.0, where c and d are the areas of the release agent with an aspect ratio of 5 or more and smaller than 5, respectively, in the toner particles, in view of the reduction of leaking toner, color spots, and fog on the finished image. Preferably, the toner particles satisfy the relation 1.5<c/d<3.5, in particular 2.0<c/d<3.0.

The measurement of the aspect ratio of the release agent in the toner is as follows.

The toner is mixed into an epoxy resin, and the epoxy resin is solidified. The resulting solid is sliced using an ultramicrotome (Leica Ultracut UCT) to give a thin section with a thickness of 80 nm or more and 130 nm or less as a sample. The thin-section sample is stained with ruthenium tetroxide for 3 hours in a desiccator at 30° C. The stained thin-section sample is imaged by scanning electron microscopy (SEM) using an ultrahigh-resolution field-emission scanning electron microscope (FE-SEM) (e.g., S-4800 from Hitachi High-Technologies Corp.). Release agents are generally stained more heavily than binder resins with ruthenium tetroxide, so the release agent is identified by shades of color caused by the degree of staining. If it is difficult to distinguish between the shades, for example because of the condition of the sample, the duration of staining is adjusted. Size may also provide the basis for identifying the release agent. In a cross-section of a toner particle, the coloring-agent domain is usually smaller than the release-agent domain.

The SEM image includes cross-sections of toner particles of various sizes. From these cross-sections, those having a diameter of 85% or more of the volume-average diameter of the toner particles are selected, and 100 of them are randomly selected and observed. Here, the diameter of a cross-section of a toner particle is defined as the longest distance between any two points on the outline of the cross-section (so-called major axis).

Each of the 100 cross-sections of toner particles selected in the SEM image is analyzed using image analysis software (WinROOF from Mitani Corp.) under the condition of 0.010000 μm/pixel. The image analysis visualizes the cross-sections of toner particles by displaying the embedding epoxy resin and the binder resin(s) in the toner particles with different levels of brightness (with a contrast therebetween). On the visualized image, the major axis and the aforementioned ratio (major axis/minor axis) and area of the release-agent domains in the toner particles can be determined.

The adjustment of the aspect ratio of the release agent in the toner may be done by several methods. For example, the toner may be maintained near the freezing point of the release agent for a certain period of time during cooling so that crystal growth will take place, or two or more release agents with different melting temperatures may be used to accelerate crystal growth during cooling.

The amount of the release agent(s) may be, for example, 1% by mass or more and 20% by mass or less, preferably 5% by mass or more and 15% by mass or less of the total mass of the toner particles.

Other Additives

Examples of other additives include magnetic substances, charge control agents, inorganic powders, and other known additives. These additives, if used, are contained in the toner particles as internal additives.

### Characteristics and Other Details of the Toner Particles

The toner particles may be single-layer toner particles or may be so-called core-shell toner particles, i.e., toner particles formed by a core section (core particle) and a coating layer that covers the core section (shell layer).

The core-shell toner particles may be formed by, for example, a core section that includes a binder resin and optionally additives, such as a coloring agent and/or a release agent, and a coating layer that includes a binder resin.

The volume-average diameter (D50v) of the toner particles may be 2 μm or more and 10 μm or less, preferably 4 μm or more and 8 μm or less.

The volume-average diameter of the toner particles is that measured using a Coulter Multisizer II (Beckman Coulter) and an ISOTON-II electrolyte (Beckman Coulter).

The measurement is as follows. A sample for measurement weighing 0.5 mg or more and 50 mg or less is added to 2 ml of a 5% by mass aqueous solution of a surfactant (e.g., a sodium alkylbenzene sulfonate) as a dispersant. The resulting dispersion is added to 100 ml or more and 150 ml or less of the electrolyte.

With the sample suspended therein, the electrolyte is sonicated for 1 minute using a sonicator. The resulting dispersion is analyzed using Coulter Multisizer II with an aperture size of 100 μm to determine the particle size distribution of those particles that are 2 μm or more and 60 μm or less across. The number of particles sampled is 50000.

The determined particle size distribution is divided into segments by particle size (channels), and the cumulative distribution of volume is plotted starting from the smallest diameter. The particle diameter at which the cumulative volume is 50% is defined as the volume-average diameter D50v.

The toner particles may have any average roundness. In view of easier cleaning of the toner off the image carrier, however, the average roundness may be 0.91 or more and 0.98 or less, preferably 0.94 or more and 0.98 or less, more preferably 0.95 or more and 0.97 or less.

The average roundness of the toner particles is given by (circumference of the equivalent circle)/(circumference) [(circumference of circles having the same projected area as the particle images)/(circumference of the projected images of the particles)]. A specific way of determining it is as follows.

First, a number of the toner particles of interest are sampled by aspiration. By photographing the resulting flat stream with a flash, the figures of the particles therein are captured in a still image. Then the particle images are analyzed using a flow particle-image analyzer (Sysmex FPIA-3000) to determine the average roundness. The number of particles sampled in the determination of the average roundness is 3500.

If the toner contains an external additive, the toner (developer) of interest is dispersed in water containing a surfactant and sonicated. This gives toner particles isolated from the external additive.

The average roundness of the toner particles may be controlled by several methods. For example, if the toner particles are produced by aggregation and coalescence, the average roundness may be controlled by adjusting the speed of agitation of the liquid dispersion, temperature of the liquid dispersion, or time for which the liquid dispersion is maintained during fusion and coalescence.

External Additives

An example of an external additive is inorganic particles. Examples of such inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂) n, Al₂O₃.2SiO₂, CaCO₃, MgCO₃, BaSO₄, and MgSO₄.

The surface of the inorganic particles as an external additive may be hydrophobic as a result of treatment. An example of a hydrophobic treatment is to immerse the inorganic particles in an agent for hydrophobic treatment. Any kind of agent may be used, but examples include silane coupling agents, silicone oil, titanate coupling agents, and aluminum coupling agents. One of these may be used alone, or two or more may be used in combination.

The amount of the agent(s) for hydrophobic treatment is usually 1 part by mass or more and 10 parts by mass or less, for example, per 100 parts by mass of the inorganic particles.

Substances such as resin particles (particles of polystyrene, polymethyl methacrylate (PMMA), melamine resins, etc.) and active cleaning agents (e.g., metal salts of higher fatty acids, typically zinc stearate, and particles of fluoropolymers) are also examples of external additives.

The amount of external additives may be, for example, 0.01% by mass or more and 10% by mass or less, preferably 0.01% by mass or more and 6% by mass or less, of the toner particles.

Production of the Toner

Next is described a method for producing the specific toner.

The specific toner is obtained by producing toner particles and then adding external additive(s) to the toner particles.

The production of the toner particles may be by a dry process (e.g., kneading and milling) or a wet process (e.g., aggregation and coalescence, suspension polymerization, or dissolution and suspension). Besides these, any known process may be used to produce the toner particles.

Preferably, the toner particles are obtained by aggregation and coalescence.

If the toner particles are produced by aggregation and coalescence, an example of a specific procedure includes:

preparing a resin-particle dispersion as a liquid dispersion in which resin particles to serve as a binder resin are dispersed (preparation of a resin-particle dispersion); making the resin particles (and optionally other kind(s) of particles) aggregate in the resin-particle dispersion (or a liquid dispersion prepared by mixing with other liquid dispersion(s) of particles) to form aggregates (formation of aggregates); heating the liquid dispersion in which the aggregates are dispersed, or aggregate dispersion, to make the aggregates fuse and coalesce together, thereby forming toner particles (fusion and coalescence).

The following describes the details of each operation.

It should be noted that the method described below gives toner particles that include a coloring agent and a release agent, but the coloring agent and the release agent are optional. Naturally, additives other than a coloring agent and a release agent may also be used.

### Preparation of a Resin-Particle Dispersion

First, a liquid dispersion in which resin particles to serve as a binder resin are dispersed (resin-particle dispersion) is prepared. In addition to this, a liquid dispersion in which particles of a coloring agent are dispersed (coloring-agent-particle dispersion) and a liquid dispersion in which particles of a release agent are dispersed (release-agent-particle dispersion), for example, are prepared.

The preparation of the resin-particle dispersion is by, for example, dispersing the resin particles in a dispersion medium using a surfactant.

The dispersion medium for the resin-particle dispersion may be, for example, an aqueous medium.

Examples of aqueous media include kinds of water, such as distilled water and ion exchange water, and alcohols. One of these may be used alone, or two or more may be used in combination.

The surfactant may be, for example, an anionic surfactant, such as a sulfate surfactant, sulfonate surfactant, phosphate surfactant, or soap surfactant; a cationic surfactant, such as an amine or quaternary ammonium surfactant; or a nonionic surfactant, such as a polyethylene glycol, alkylphenol ethylene oxide, or polyhydric alcohol surfactant, in particular an anionic or cationic surfactant. Nonionic surfactants, if used, may be used in combination with an anionic or cationic surfactant.

One surfactant may be used alone, or two or more may be used in combination.

In preparing the resin-particle dispersion, the process of dispersing the resin particles in the dispersion medium may be done by a commonly used dispersion technique, such as a rotary-shear homogenizer or a ball mill, sand mill, Dyno-Mill, or other medium mill. For certain types of resin particles, phase inversion emulsification, for example, may be used to disperse the resin particles in the resin-particle dispersion.

Phase inversion emulsification is a technique in which the resin to be dispersed is dissolved in a hydrophobic organic solvent in which the resin is soluble, the resulting organic continuous phase (O phase) is neutralized with a base, and then an aqueous medium (W phase) is added to convert the resin from W/O to O/W (so-called phase inversion), creating a discontinuous phase and thereby dispersing particles of the resin in the aqueous medium.

The volume-average diameter of the resin particles to be dispersed in the resin-particle dispersion may be, for example, 0.01 μm or more and 1 μm or less, preferably 0.08 μm or more and 0.8 μm or less, more preferably 0.1 μm or more and 0.6 μm or less.

This volume-average diameter of the resin particles is the volume-average particle diameter D50v determined as follows. The particles are analyzed using a laser-diffraction particle size analyzer (e.g., HORIBA LA-700). The measured particle size distribution is divided into segments by particle size (channels). The cumulative distribution of volume is plotted starting from the smallest diameter. The particle diameter at which the cumulative volume is 50% of that of all particles is the volume-average particle diameter D50v. For the other dispersions, too, the volume-average diameter of the particles therein is that determined by the same method.

The amount of the resin particles in the resin-particle dispersion may be, for example, 5% by mass or more and 50% by mass or less, preferably 10% by mass or more and 40% by mass or less.

The preparation of the coloring-agent-particle and release-agent-particle dispersions, for example, is similar to that of the resin-particle dispersion. The above discussion on the volume-average particle diameter, dispersion medium, method of dispersion, and amount for the particles in the resin-particle dispersion therefore also applies to the coloring-agent particles dispersed in the coloring-agent-particle dispersion and the release-agent particles dispersed in the release-agent-particle dispersion. Formation of Aggregates

Then, the resin-particle dispersion is mixed with the coloring-agent-particle and release-agent-particle dispersions.

In the mixture of dispersions, the resin particles, the coloring-agent particles, and the release-agent particles are caused to aggregate together. Through this process of heteroaggregation, aggregates that include resin, coloring-agent, and release-agent particles are formed to a diameter close to the planned diameter of the toner particles.

A specific example of a procedure is as follows. A flocculant is added to the dispersion mixture, and the pH of the mixture is adjusted to an acidic level (e.g., a pH of 2 or more and 5 or less). At this point, a dispersion stabilizer may optionally be added. The dispersion mixture is then heated to a temperature close to the glass transition temperature of the resin particles (specifically, for example, a temperature higher than or equal to the resin particles' glass transition temperature minus 30° C. but not higher than the resin particles' glass transition temperature minus 10° C.) to make the particles dispersed in the mixture aggregate together, forming aggregates.

In an exemplary configuration of the formation of aggregates, the dispersion mixture may be agitated using a rotary-shear homogenizer, and the flocculant may be added at room temperature (e.g., 25° C.) while the mixture is agitated. Then the pH of the mixture is adjusted to an acidic level (e.g., a pH of 2 or more and 5 or less) and then, optionally with a dispersion stabilizer therein, heated as described above.

The flocculant may be, for example, a surfactant that has the opposite polarity to that used as a dispersant in the dispersion mixture, an inorganic metal salt, or a metal complex having a valency of 2 or more. The use of a metal complex as a flocculant improves charging characteristics by reducing the amount of surfactants used.

An additive that forms a complex or similar linkage with metal ions of the flocculant may optionally be used. This additive may be a chelating agent.

Examples of inorganic metal salts include metal salts such as calcium chloride, calcium nitrate, barium chloride, magnesium chloride, zinc chloride, aluminum chloride, and aluminum sulfate, and polymers of inorganic metal salts, such as polyaluminum chloride, polyaluminum hydroxide, and calcium polysulfide.

The chelating agent may be a water-soluble one. Examples of chelating agents include oxycarboxylic acids, such as tartaric acid, citric acid, and gluconic acid, iminodiacetic acid (IDA), nitrilotriacetic acid (NTA), and ethylenediaminetetraacetic acid (EDTA).

The amount of the chelating agent may be, for example, 0.01 parts by mass or more and 5.0 parts by mass or less, preferably 0.1 parts by mass or more and less than 3.0 parts by mass, per 100 parts by mass of resin particles.

### Fusion and Coalescence

The aggregates are then caused to fuse and coalesce together and thereby to form toner particles, for example by heating the liquid dispersion in which the aggregates are dispersed, or aggregate dispersion, to at least the resin particles' glass transition temperature (e.g., to 10° C. to 30° C. higher than the resin particles' glass transition temperature or a higher temperature).

The fusion and coalescence of the aggregates into toner particles may alternatively be achieved by heating the aggregate dispersion to at least the melting temperature of the release agent. In the process of fusion and coalescence, the resin and release agent fuse together at a temperature that is higher than or equal to the glass transition temperature of the resin particles and higher than or equal to the melting temperature of the release agent. The heated aggregate dispersion is then cooled to give toner particles.

The adjustment of the aspect ratio of the release agent in the toner may be done by several methods. For example, the toner may be maintained near the freezing point of the release agent for a certain period of time during cooling so that crystal growth will take place, or two or more release agents with different melting temperatures may be used to accelerate crystal growth during cooling.

Through these operations, the toner particles are obtained.

Alternatively, the toner particles may be produced as follows. After the preparation of the liquid dispersion in which aggregates are dispersed (aggregate dispersion), this aggregate dispersion is mixed with another liquid dispersion in which resin particles are dispersed (resin-particle dispersion), and the resin particles and the aggregates are caused to aggregate together in such a manner that the resin particles adhere to the surface of the aggregates. This gives second aggregates. The resulting liquid dispersion in which the second aggregates are dispersed, or second-aggregate dispersion, is heated to make the second aggregates fuse and coalesce and thereby form core/shell toner particles.

After the end of fusion and coalescence, the toner particles, formed in a solution, are subjected to known operations of washing, solid-liquid separation, and drying to give dry toner particles.

The washing may be by replacement with plenty of ion exchange water in view of ease of charging. The solid-liquid separation may be by any method, but techniques such as suction filtration and pressure filtration may be used in view of productivity. The drying, too, may be by any method, but techniques such as lyophilization, flash drying, fluidized drying, and vibrating fluidized drying may be used in view of productivity.

The specific toner is then produced, for example by mixing the resulting dry toner particles with external additive(s). The mixing may be performed using, for example, a V-blender, Henschel mixer, or Lödige mixer. The toner may optionally be sieved, for example through a vibrating sieve or air-jet sieve, to remove coarse particles.

### Carrier

Any type of carrier may be used, and examples include known carriers. The carrier may be, for example, a coated carrier, which is formed by covering the surface of a core magnetic powder with a coating resin; a magnetic powder-dispersed carrier, formed by dispersing and mixing a magnetic powder in a matrix resin; or a resin-impregnated carrier, formed by impregnating a porous magnetic powder with a resin.

A magnetic powder-dispersed or resin-impregnated carrier may be one formed by the constituting particles as a core and a coating resin covering this core.

Examples of magnetic powders include powders of magnetic metals, such as iron, nickel, and cobalt, and magnetic oxides, such as ferrite and magnetite.

For the coating and matrix resins, examples include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins, which include organosiloxane bonds, or their modified forms, fluoropolymers, polyester, polycarbonate, phenolic resins, and epoxy resins.

The coating and matrix resins may contain additives, such as conductive particles.

Examples of conductive particles include particles of gold, silver, copper, or any other metal, carbon black, titanium oxide, zinc oxide, tin oxide, barium sulfate, aluminum borate, and potassium titanate.

The covering of the surface of the core with a coating resin may be by, for example, covering the surface of the core using a solution of the coating resin and optionally additives in a solvent (solution for coating layer formation). The solvent may be of any kind and is selected in consideration of, for example, the coating resin used and suitability for application.

Specific examples of methods of resin coating include dipping, which means immersing the core in the solution for coating layer formation, spraying, which means spraying the solution for coating layer formation onto the surface of the core, the fluidized bed method, in which the core is caused to float on flowing air and sprayed with the solution for coating layer formation in that state, and the kneader-coater method, in which mixing of the core for the carrier with the solution for coating layer formation and removal of the solvent are performed in a kneader-coater.

For a two-component developer, the mixing ratio (by mass) between the toner and the carrier may be between 1:100 and 30:100 (toner:carrier), preferably between 3:100 and 20:100.

### Image Forming Apparatus

An image forming apparatus according to this exemplary embodiment is described in detail.

An image forming apparatus according to this exemplary embodiment includes an image carrier; a charging section that charges the surface of the image carrier; an electrostatic charge image forming section that forms an electrostatic charge image on the charged surface of the image carrier; a developing section that includes a container containing an electrostatic charge image developer and also includes a transporter for the electrostatic charge image developer, the electrostatic charge image developer including toner for electrostatic-charge-image development and a carrier, the transporter having a rotary shaft and multiple helical blades on the outer circumferential surface of the rotary shaft with a phase shift therebetween, the helical blades having a break zone, a zone in which the helical blades are discontinuous along the axis of the rotary shaft; a transfer section that transfers the toner image formed on the surface of the image carrier to a substrate; and a fixing section that fixes the toner image transferred to the substrate. The toner satisfies the following relations:

(ln η(T1)−ln η(T2))/(T1−T2)≤−0.14;

(ln η(T2)−ln η(T3))/(T2−T3)≥−0.15; and

(ln η(T1)−ln η(T2))/(T1−T2)<(ln η(T2)−ln η(T3))/(T2−T3),

where η(T1) represents the viscosity of the toner at 60° C., η(T2) represents the viscosity of the toner at 90° C., and η(T3) represents the viscosity of the toner at 130° C.

The toner is the aforementioned specific toner.

An image forming apparatus according to this exemplary embodiment performs a method of image formation that includes charging, in which the surface of the image carrier is charged; electrostatic-charge-image formation, in which an electrostatic charge image is formed on the charged surface of the image carrier; development, in which the electrostatic charge image formed on the surface of the image carrier is developed into a toner image using an electrostatic charge image developer that includes a specific toner; transfer, in which the toner image formed on the surface of the image carrier is transferred to the surface of a substrate (hereinafter also referred to as a “recording medium”); and fixation, in which the toner image transferred to the surface of the substrate is fixed.

The scope of application of an image forming apparatus according to this exemplary embodiment includes known types of image forming apparatuses, such as direct-transfer apparatuses, which operate by forming a toner image on the surface of an image carrier and transferring it directly to a recording medium; intermediate-transfer apparatuses, which operate by forming a toner image on the surface of an image carrier, transferring it to the surface of an intermediate transfer body (first transfer), and then transferring the toner image on the surface of the intermediate transfer body to the surface of a recording medium (second transfer);

apparatuses that include a cleaning component that cleans the surface of the image carrier between the transfer of a toner image and charging; and apparatuses that include a static eliminator component that removes static electricity from the surface of the image carrier by irradiation with antistatic light between the transfer of a toner image and charging.

If an image forming apparatus according to this exemplary embodiment is an intermediate-transfer apparatus, the transfer component has, for example, an intermediate transfer body, a first-transfer component, and a second-transfer component. A toner image formed on the surface of the image carrier is transferred by the first-transfer component to the surface of the intermediate transfer body (first transfer). The toner image transferred to the surface of the intermediate transfer body is then transferred by the second-transfer component to the surface of a recording medium (second transfer).

Part of an image forming apparatus according to this exemplary embodiment, for example a portion including the developing section, may have a cartridge structure, a structure that allows the part to be attached to and detached from the image forming apparatus (i.e., may be a process cartridge). An example of a process cartridge that may be used is one that includes a developing section that contains an electrostatic charge image developer according to this exemplary embodiment.

The following describes an example of an image forming apparatus according to this exemplary embodiment. It should be noted that this is not the only example. The following description is focused on structural elements illustrated in a drawing.

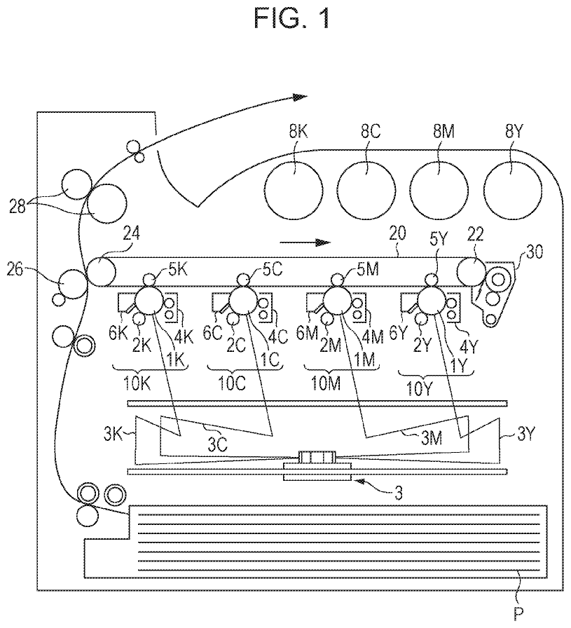

FIG. 1 schematically illustrates the structure of an image forming apparatus according to this exemplary embodiment.

The image forming apparatus illustrated in FIG. 1 includes first to fourth electrophotographic image forming units 10Y, 10M, 10C, and 10K (image forming component) that produce images in the colors of yellow (Y), magenta (M), cyan (C), and black (K), respectively, based on color-separated image data. The image forming units (hereinafter also referred to simply as “units”) 10Y, 10M, 10C, and 10K are arranged in a horizontal row, spaced apart by a predetermined distance. The units 10Y, 10M, 10C, and 10K may be process cartridges that are attached to and detached from the image forming apparatus.

Above the units 10Y, 10M, 10C, and 10K, an intermediate transfer belt (example of an intermediate transfer body) 20 extends via each of the units. The intermediate transfer belt 20 is wound over a drive roller 22 and a support roller 24, both touching the inner surface of the intermediate transfer belt 20, and runs in the direction from the first unit 10Y to the fourth unit 10K. A spring or similar mechanism not illustrated applies force to the support roller 24 to bring it away from the drive roller 22, placing tension on the intermediate transfer belt 20 wound over the two rollers. On the image-carrying side of the intermediate transfer belt 20 is an intermediate-transfer-belt-cleaning device 30 facing the drive roller 22.

The developing devices (example of developing sections) 4Y, 4M, 4C, and 4K of the units 10Y, 10M, 10C, and 10K are fed with toners in yellow, magenta, cyan, and black, respectively, contained in toner cartridges 8Y, 8M, 8C, and 8K.

The first to fourth units 10Y, 10M, 10C, and 10K are equivalent in structure and operation. In the following, the first unit 10Y, which is located upstream of the others in the direction of running of the intermediate transfer belt and forms a yellow image, is described to represent the four units.

The first unit 10Y has a photoreceptor 1Y that operates as an image carrier. Around the photoreceptor 1Y are a charging roller (example of a charging component) 2Y that charges the surface of the photoreceptor 1Y to a predetermined potential, an exposure device (example of an electrostatic charge image forming component) 3 that irradiates the charged surface with a laser beam 3Y based on a color-separated image signal to form an electrostatic charge image there, a developing device (example of developing sections) 4Y that supplies charged toner to the electrostatic charge image to develop the electrostatic charge image, a first-transfer roller (example of a first-transfer component) 5Y that transfers the developed toner image to the intermediate transfer belt 20, and a photoreceptor-cleaning device (example of an image-carrier-cleaning component) 6Y that removes any toner remaining on the surface of the photoreceptor 1Y after the first transfer, arranged in order.

The first-transfer roller 5Y is inside the intermediate transfer belt 20 and faces the photoreceptor 1Y. The first-transfer rollers 5Y, 5M, 5C, and 5K of the units are connected to bias power supplies (not illustrated) that apply a first transfer bias to the rollers. The bias power supplies change the value of the transfer bias they apply to the first-transfer rollers under the control of a controller not illustrated.

The following describes how the first unit 10Y operates to form a yellow image.

First, in advance of the operations, the charging roller 2Y charges the surface of the photoreceptor 1Y to a potential of −600 V to −800 V.

The photoreceptor 1Y is a stack of a conductive (e.g., the volume resistivity at 20° C. is 1×10⁻⁶ Ωcm or less) substrate and a photosensitive layer thereon. The photosensitive layer is highly resistant (has the typical resistance of a resin) in its normal state, but when irradiated with a laser beam, changes resistivity in the portion irradiated with the laser beam. Therefore, the charged surface of the photoreceptor 1Y is irradiated with a laser beam 3Y. The laser beam 3Y is emitted from the exposure device 3 and is based on image data for yellow sent from a controller not illustrated. This forms an electrostatic charge image for a yellow image pattern on the surface of the photoreceptor 1Y.

The electrostatic charge image is an image formed on the surface of the photoreceptor 1Y using charge. The laser beam 3Y decreases the resistivity of the irradiated portion of the photosensitive layer, causing the charge on the surface of the photoreceptor 1Y to leave. The charge on the portion not irradiated with the laser beam 3Y stays. Produced in this way, the electrostatic charge image is a so-called negative latent image.

As the photoreceptor 1Y rotates, the electrostatic charge image formed on the photoreceptor 1Y rotates to a predetermined developing position. At the developing position, the electrostatic charge image on the photoreceptor 1Y is visualized by being developed into a toner image by the developing device 4Y.

The developing device 4Y contains an electrostatic charge image developer that includes, for example, at least yellow toner and a carrier. The yellow toner has been agitated inside the developing device 4Y and thereby triboelectrically charged with the same polarity as the charge on the photoreceptor 1Y (negative). With this polarity of charge, the yellow toner is on a developing roller (example of a developer holding member). The passage of the surface of the photoreceptor 1Y through the developing device 4Y causes the yellow toner to electrostatically adhere to the latent image portion, from which static electricity has been removed, of the surface of the photoreceptor 1Y. As a result, the latent image is developed by the yellow toner. The photoreceptor 1Y with a yellow toner image thereon continues to be rotated at a predetermined speed, transporting the toner image developed thereon to a predetermined first-transfer position.

On the arrival of the yellow toner image on the photoreceptor 1Y at the first-transfer position, a first transfer bias is applied to the first-transfer roller 5Y. Electrostatic force directed from the photoreceptor 1Y to the first-transfer roller 5Y acts on the toner image, transferring the toner image on the photoreceptor 1Y to the intermediate transfer belt 20. The polarity of this transfer bias is (+), opposite the polarity of the toner (−). For the first unit 10Y, the controller (not illustrated) controls the transfer bias to, for example, +10 μA. Any residual toner on the photoreceptor 1Y is removed and collected at the photoreceptor-cleaning device 6Y.

For the second unit 10M and the later units, too, the first transfer bias applied to the first-transfer roller 5M, 5C, or 5K is controlled in the same way as that for the first unit.

After receiving a yellow toner image at the first unit 10Y in this way, the intermediate transfer belt 20 is moved to pass through the second unit 10M, third unit 10C, and then fourth unit 10K. Toner images in the respective colors are transferred, one laid over another (multilayer transfer).

After the multilayer transfer of toner images in four colors by the first to fourth units, the intermediate transfer belt 20 reaches a second-transfer section. The second transfer section is composed of the intermediate transfer belt 20, the support roller 24, which is contacting the inner surface of the intermediate transfer belt 20, and a second-transfer roller (example of a second-transfer component) 26 on the image-carrying side of the intermediate transfer belt 20. A feeding mechanism delivers recording paper (example of a recording medium) P into the gap between the second-transfer roller 26 and the intermediate transfer belt 20 in a timed manner, and a second transfer bias is applied to the support roller 24. The polarity of this transfer bias is (−), the same as the polarity of the toner (−). Electrostatic force directed from the intermediate transfer belt 20 to the recording paper P acts on the toner image, transferring the toner image on the intermediate transfer belt 20 to the recording paper P. There is a resistance detector (not illustrated) that detects the resistance of the second-transfer section, and the second transfer bias is determined, or controlled, in accordance with the resistance detected by this resistance detector.

The recording paper P with a toner image thereon is sent to a section of a fixing device (example of a fixing component) 28 in which a pair of fixing rollers are pressed against each other (nip section). The toner image is fixed on the recording paper P, producing a fixed image. After the completion of the fixation of the color image, the recording paper P is transported to an ejection section to finish a series of operations for the formation of a color image.

The recording paper P, to which the toner image is transferred, may be, for example, paper for duplicators, printers, etc., of electrophotographic type. The recording medium does not need to be recording paper P. For example, overhead-projector (OHP) film is another example of a recording medium. The fixed image may be given a smoother finish by the use of recording paper P having a smooth surface. Examples include coated paper, which is paper whose surface has a resin or other coating, and art paper, which is high-grade coated paper for printing purposes.

After the completion of the fixation of the color image, the recording paper P is transported to an ejection section to finish a series of operations for the formation of a color image.

### Process Cartridge

A process cartridge according to this exemplary embodiment is one that includes a developing section and is attached to and detached from an image forming apparatus. The developing section contains an electrostatic charge image developer according to this exemplary embodiment and develops an electrostatic charge image formed on the surface of an image carrier into a toner image using the electrostatic charge image developer.

This is not the only possible configuration of a process cartridge according to this exemplary embodiment. For example, the process cartridge may include a developing device and optionally at least one selected from other components such as an image carrier, a charging component, an electrostatic charge image forming component, and a transfer component.

The following describes an example of a process cartridge according to this exemplary embodiment. It should be noted that this is not the only example. The following description is focused on structural elements illustrated in a drawing.

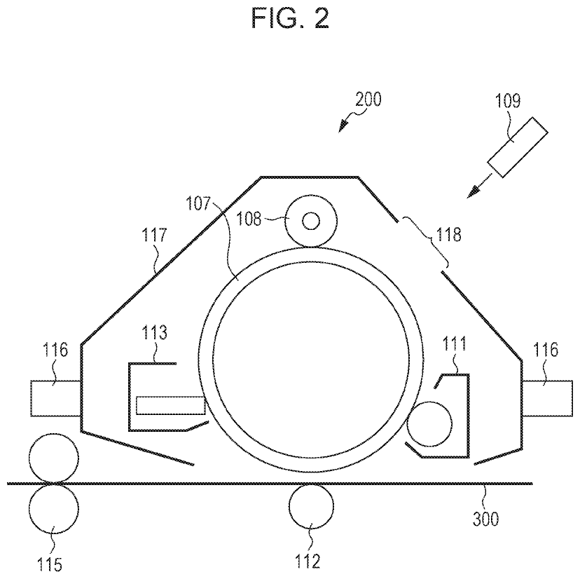

FIG. 2 schematically illustrates the structure of an example of a process cartridge according to this exemplary embodiment.

The process cartridge 200 illustrated in FIG. 2 is composed of, for example, a housing 117 and a photoreceptor 107 (example of an image carrier) therein. The housing 117 has attachment rails 116 and an opening 118 for exposure to light. Around the photoreceptor 107 are a charging roller 108 (example of a charging component), a developing device 111 (example of a developing section), and a photoreceptor-cleaning device 113 (example of a cleaning component). The housing 117 holds these components inside together to form a cartridge.

FIG. 2 also includes an exposure device 109 (example of an electrostatic charge image forming component), a transfer device 112 (example of a transfer component), a fixing device 115 (example of a fixing component), and recording paper 300 (example of a recording medium).

Toner Cartridge

Next is described a toner cartridge used in this exemplary embodiment.

A toner cartridge used in this exemplary embodiment is one that contains a specific toner used in this exemplary embodiment and is attached to and detached from an image forming apparatus. The toner cartridge contains replenishment toner, toner intended to be supplied to a developing section built in an image forming apparatus.

The image forming apparatus illustrated in FIG. 1 is one configured so that toner cartridges 8Y, 8M, 8C, and 8K are attached thereto and detached therefrom. The developing devices 4Y, 4M, 4C, and 4K are connected to the toner cartridges for their respective colors by toner feed pipe not illustrated. When there is little toner in a toner cartridge, this toner cartridge is replaced.

Structure of Elements

Next is described a developing section used in this exemplary embodiment in detail.

A developing section used in this exemplary embodiment is one that contains a specific toner and develops an electrostatic charge image formed on the surface of an image carrier into a toner image using the specific toner. The developing section also includes a transporter that transports the specific toner while agitating it. The transporter has a rotary shaft and multiple helical blades on the outer circumferential surface of the rotary shaft, and there is a phase shift between the helical blades. At least one of the helical blades has a break zone, a zone in which the helical blade(s) is discontinuous along the axis of the rotary shaft.

The rate of the axial length of the section of the rotary shaft with the helical blades therearound to the whole axial length of the rotary shaft (in other words, the axial length of the rotary shaft excluding the section in which the helical blades do not complete a single turn on the outer circumferential surface of the rotary shaft) may be 40% or more, preferably 50% or more, in view of the transport of the toner. As for the upper limit, this percentage may be 95% or less, preferably 90% or less, in view of the agitating of the toner.

The following describes an exemplary embodiment with reference to drawings.

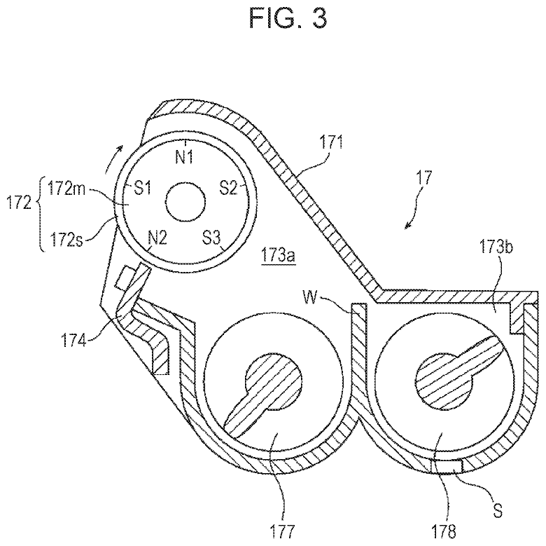

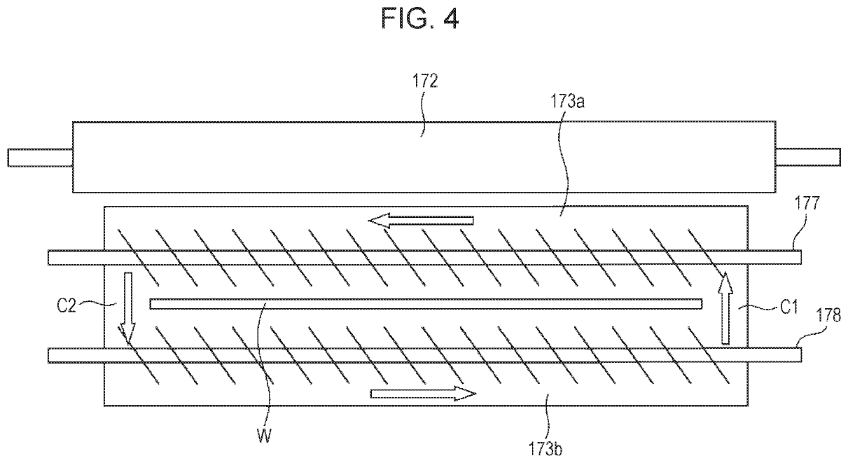

FIGS. 3 and 4 are schematic cross-sectional side and plan views, respectively, of a developing section used in this exemplary embodiment.

A developing device 4 (example of a “developing section”) used in this exemplary embodiment is a so-called two-component development system. As illustrated in FIGS. 3 and 4, the developing device 4 has a developing housing 171 that has an opening on the side facing a photoreceptor (example of an “image carrier”). A developing roller 172 as a holding member of the developer faces this opening of the developing housing 171. The developing device 4, moreover, has a first developer chamber 173a and a second developer chamber 173b in the section of the developing housing 171 next to the developing roller 172. The first developer chamber 173a is for containing a two-component developer, and the second developer chamber 173b is adjacent to the first developer chamber 173a. Although there is a partitioning wall W therebetween, the second developer chamber 173a communicates with the first developer chamber 173a at its axial ends.

Each of the first and second developer chambers 173a and 173b has a space in which a two-component developer is to be contained. In the first developer chamber 173a, there is a first developer agitator-transporter 177 (example of a “transporter”), a spiral element that transports the two-component developer in a predetermined axial direction. In the second developer chamber 173b, there is a second developer agitator-transporter 178 (example of a “transporter”), which is also a spiral element but transports the two-component developer in the direction opposite the first developer agitator-transporter 177. Together with communication openings C1 and C2 at the axial (longitudinal) ends of the partitioning wall W, the first and second developer chambers 173a and 173b form a developer loop. In this developer loop, the paired spiral first and second developer agitator-transporters 177 and 178 circulate the two-component developer while agitating and mixing it.

Each of the first and second developer agitator-transporters 177 and 178 is a so-called auger, a tool that has a rotary shaft and helical blades on the outer circumferential surface of the rotary shaft. The helical blades are integral with the rotary shaft, and the entire tool can rotate freely. The first developer agitator-transporter 177, closer to the developing roller 172, is a supply auger, which not only agitates and mixes the toner but also supplies the developer to the developing roller 172. The second developer agitator-transporter 178 is an admix auger, which agitates and mixes replenishment toner with the two-component developer that has already been there. Further details of the admix auger 178 as a developer agitator-transporter used in this embodiment will be discussed later.

In this exemplary embodiment, an example of a “transporter” is an auger. For example, the supply and admix augers illustrated in FIGS. 3 and 4 are examples of transporters used in this exemplary embodiment.

The developing device 4, moreover, has a developer inlet (not illustrated), an opening through which the developer is supplied, upstream in the second developer chamber 173b and also has a toner density sensor S downstream in the second developer chamber 173b. In the section next to the second developer chamber 173b is a dispense auger not illustrated. If the density of the toner inside the developer chambers 173a and 173b falls below a predetermined limit as a result of a development process, fresh toner is supplied from a toner cartridge not illustrated into the second developer chamber 173b via the dispense auger, not illustrated, and comes in through the toner inlet in response to detection by the toner density sensor S, placed in a downstream bottom area of the second developer chamber 173b. In this exemplary embodiment, the two-component developer is a developer composed of toner and a magnetic carrier. An example of a toner is a nonmagnetic toner, but it is acceptable to use a magnetic toner if its charging characteristics are different from those of the magnetic carrier.

In this exemplary embodiment, the developing roller 172 includes a developing sleeve 172s and a magnet roller 172m. The developing sleeve 172s rotates in a predetermined direction (clockwise in this example) during development, and the magnet roller 172m is stationary inside the developing sleeve 172s.

As well as rotating in a predetermined direction, the developing sleeve 172s is placed in the opening of the developing housing 171, or the area where the developing housing 171 faces a photoreceptor (hereinafter also referred to as the developing area), to face a photoreceptor with a predetermined distance therebetween. The developing sleeve 172s, moreover, is connected to a developing-bias power supply not illustrated, a power supply for producing a developing electric field in the space between it and the photoreceptor (developing area).

The magnet roller 172m as a component for generating a magnetic field is a roller formed by multiple magnets arranged circumferentially. The magnet roller 172m has a developing pole S1 at the position corresponding to the developing area. The magnet roller 172m may also have, for example, a transport pole N1 and a pick-off pole S2 at predetermined angular distances downstream of the developing pole S1 in the direction of rotation of the developing roller 172 and a trimming pole N2 and a pick-up pole S3 at predetermined angular distances upstream of the developing pole S1. Such a magnet roller 172m having a series of poles inside generates a predetermined distribution of magnetic flux density, which corresponds to the magnetic forces of the poles, in the developing roller 172. The magnet roller 172m can have any appropriate number of poles at any appropriate positions.

In this exemplary embodiment, moreover, a thickness limiter 174 faces the developing roller 172 (trimming pole N2) from immediately beneath the trimming pole N2 of the developing roller 172. The thickness limiter 174 is dog-leg in shape and extends along the axis of the developing roller 172. To limit the amount of two-component developer on the developing roller 172, the thickness limiter 174 is close to but a predetermined distance away from the developing roller 172.

During development, in which the developing roller 172 rotates in a predetermined direction (clockwise in this example), the two-component developer in the first developer chamber 173a is agitated and transported by the supply auger 177 and lifted by the pick-up pole S3 of the developing roller 172. The lifted two-component developer is then transported in the direction of rotation of the developing roller 172 (developing sleeve 172s) by the magnetic attraction of the pick-up pole S3 and the friction between the developer and the surface of the developing roller 172. As the developer approaches the thickness limiter 174, the trimming pole N2 acts on the developer to make it form chains. With their growth limited by the thickness limiter 174, these chains of the two-component developer are shaped into a layer to a predetermined thickness on the developing roller 172 and transported in this form of developer layer to the developing area. After the layer of the two-component developer has been transported to the developing area, the magnetic attraction to the developing pole S1 causes the developer to form a magnetic brush. The toner in the two-component developer forming this magnetic brush visualizes the electrostatic latent image on the photoreceptor in response to a developing electric field generated between the photoreceptor and the developing roller 172. Any excessive toner past the developing area moves with the rotation of the developing roller 172 and is guided back to the first developer chamber 173a by the magnetic force of the pick-off pole S2. Such a development operation consumes a certain amount of the two-component developer, and as much fresh two-component developer is supplied from the second developer chamber 173b to the first developer chamber 173a so that the developing device 17 can operate continuously.

### First Exemplary Embodiment

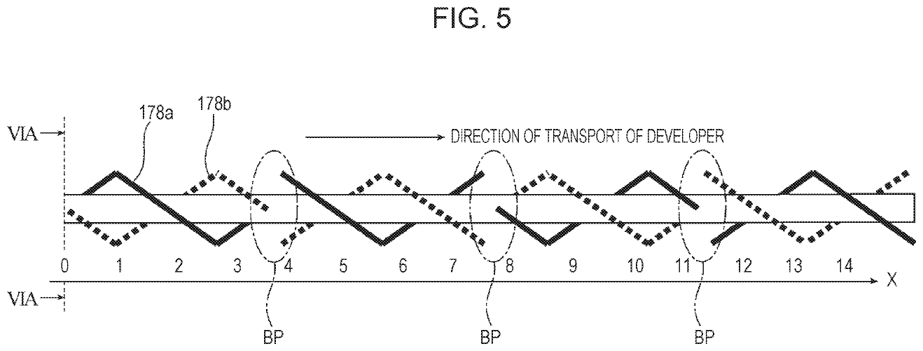

Next is described a transporter used in a first exemplary embodiment. As an example, the structure of a developer agitator-transporter (admix auger in this example) 178 is described with reference to FIG. 5. FIG. 5 schematically illustrates an admix auger as part of a developing section used in the first exemplary embodiment.

As schematically illustrated in FIG. 5, the admix auger 178 has two helical blades 178a (solid line in the drawing) and 178b (dot line in the drawing) wound around a rotary shaft. At multiple points along the axis, there are break portions (dash-dot lines in the drawing) BP, zones in which the helical blades 178a and 178b are discontinuous along the axis (helical blades 178a and 178b are broken). The helical blades 178a and 178b in actual settings may have a curved, substantially sinusoidal ridge, but FIG. 5 illustrates them as being linear for the sake of brevity.

The helical blades 178a and 178b have the same diameter and the same pitch, but there is a phase shift of 180° with regard to circumferential positions on the rotary shaft.

As can be seen from this, the transporter used in this exemplary embodiment may have the multiple helical blades on the outer circumferential surface of the rotary shaft in an equally phased arrangement.

An equally phased arrangement of multiple helical blades means that the phase shift between one helical blade and another is constant all along the axis. The phase shift is considered constant if it is within ±5° throughout.

The use of multiple (two in this example) helical blades 178a and 178b, compared with one helical blade, multiplies the area of the transport surface, the surface on which the two-component developer is transported, in the cross-section perpendicular to the axis. This configuration therefore helps accelerate the axial transport of the two-component developer.

Even with multiple (two in this example) helical blades 178a and 178b, however, the circumferential agitating and mixing of the developer is not improved greatly. If the two-component developer is transported along the axis with the toner and carrier therein not fully agitated together and delivered in that state to the supply auger 177, image defects such as uneven density can occur.

To counter this, the admix auger 178 used in this exemplary embodiment has in its helical blades 178a and 178b break portions BP as described below. The break portions BP make the multiple helical blades 178a and 178b effective in improving both agitating and mixing and axial transport.

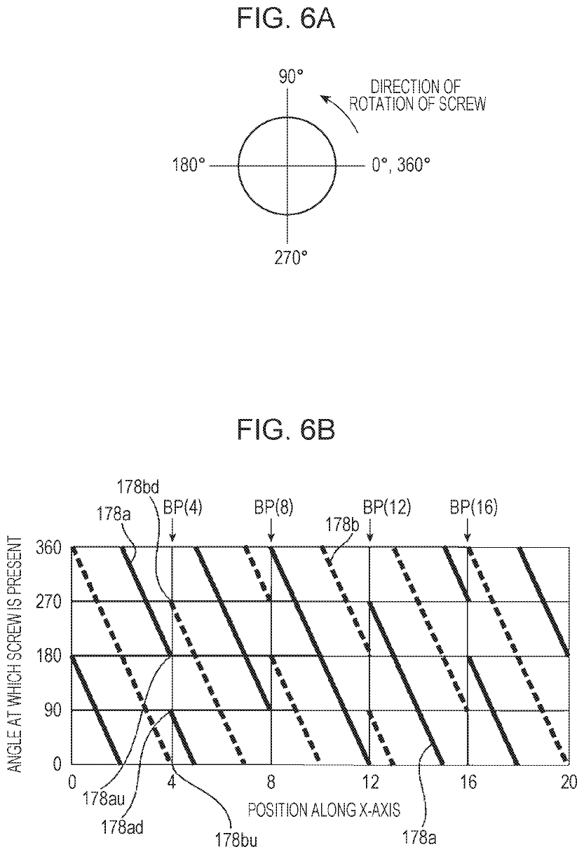

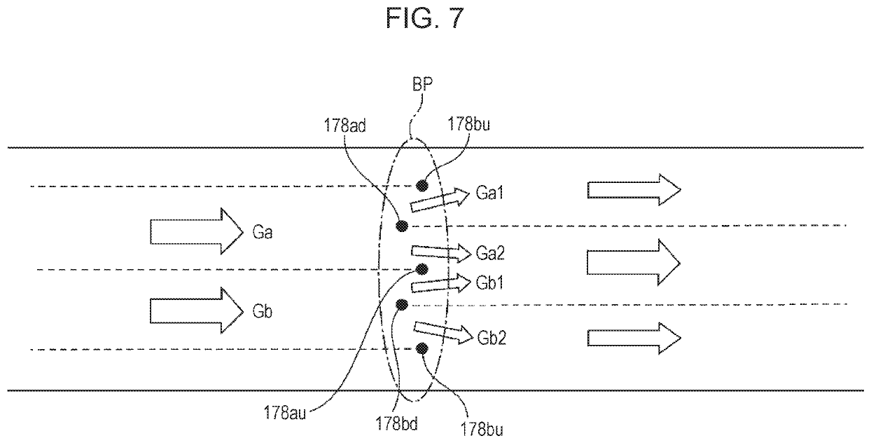

Next is described the structure and operation of the break portions BP of the admix auger 178 in further detail with reference to FIGS. 6 and 7. FIG. 6A schematically illustrates the direction of rotation and angular regions of the admix auger 178, and FIG. 6B schematically illustrates the angular regions in which the auger's helical blades are present versus the position along the axis. FIG. 7 is a schematic diagram for describing how a break portion BP works.

As schematically illustrated in FIG. 6A, the helical blades 178a and 178b rotate counterclockwise when viewed from line VIA-VIA in FIG. 5. As they rotate, the helical blades 178a and 178b come in predetermined regions as illustrated in FIG. 6B. In FIG. 6B, the horizontal axis represents the position along the axis, and the vertical axis represents the angular regions (as defined in FIG. 6A) in which the helical blades 178a and 178b are present. In FIG. 6B, the solid line represents one helical blade 178a of the two helical blades 178a and 178b, and the dot line represents the other helical blade 178b, has 180° phase sift based on the helical blade 178a.

The transporter used in this exemplary embodiment may have at least one of its multiple helical blades with two or more break zones, zones in which the helical blade(s) is discontinuous along the axis of the rotary shaft (e.g., “break portions BP”), therein.

As best illustrated in FIG. 6B, in each of the break portions BP (the four points at X (4), X (8), X (12), and X (16) in the drawing in this example), the upstream end 178au or 178bu and the downstream end 178ad or 178bd of the helical blades 178a and 178b, facing each other across the break portion BP, are positioned so that there is a phase shift of 90° therebetween (90° phase sift). For example, in the break portion BP (4), which is at X (4), the upstream end 178au of the helical blade 178a is at a position of 180°, whereas the downstream end 178ad is at 90° to arrange a phase shift of 90° between the two ends. Likewise, the upstream end 178bu of the helical blade 178b is at a position of 0° (360°), whereas the downstream end 178ad is at 270° to arrange a phase shift of 90° between the two ends. In the other break portions BP (8), BP (12), and BP (16), too, the upstream end 178au or 178bu and the downstream end 178ad or 178bd of each helical blade 178a or 178b, facing each other across the break portion BP, are positioned so that there is a phase shift of 90° therebetween.

To summarize, the admix auger 178 has two helical blades 178a and 178b with a phase shift of 180° therebetween, and each helical blade end 178a or 178b has 90°-phase sifts in its break portions BP.

In the admix auger 178 having such a structure, as schematically illustrated in FIG. 7, the flow Ga of the two-component developer, transported on the transport surface of the helical blade 178a, moves to the upstream end 178au in each break portion BP and there is guided by the downstream end 178ad, facing the upstream end 178au with a 90° phase shift therebetween, to split (divide) into two flows Ga1 and Ga2. The flow Gb of the two-component developer, transported on the helical blade 178b, which has a 180° phase shift from the helical blade 178a and whose transport surface is 180° behind (or ahead of) that of the helical blade 178a, moves to the upstream end 178bu in the break portion BP and there is guided by the downstream end 178bd, facing the upstream end 178bu with a 90° phase shift therebetween, to split (divide) into two flows Gb1 and Gb2.

This means, as schematically illustrated in FIG. 7, each break portion BP divides the two-component developer Ga and Gb transported by the upstream helical blades 178a and 178b. In the break portions BP, one flow of the developer is split into two flows Ga1 and Ga2, and the other into two flows Gb1 and Gb2. The split flows Ga1, Ga2, Gb1, and Gb2 are then joined together by the downstream helical blades 178a and 178b, has 90° phase sift from the upstream counterparts at their end, to form two new flows (specifically, two flows Ga2+Gb1 and Ga1+Gb2). In this way, the break portions BP improve circumferential agitating and mixing of the two-component developer.

It should be noted that even one break portion BP present anywhere along the axis is enough for better agitating and mixing of the two-component developer via splitting/joining of the developer as described above, but there may be multiple break portions BP along the axis (at multiple points along the axis) in view of repeated splitting/joining for further improved agitating and mixing of the two-component developer.

In each break portion BP, moreover, the upstream end 178au or 178bu of the helical blades 178a and 178b may overlap the corresponding downstream end 178ad or 178bd in the axial direction (see FIG. 7). Such an axial overlap of opposite ends across each break portion BP, ones on the upstream side and the others on the downstream side (upstream ends 178au and 178bu and downstream ends 178ad and 178bd), provides smoother agitating and mixing of the two-component developer because the ends involved help the developer split/join in the break portions BP by serving as a guide.

In view of equal division of the flows Ga and Gb upstream of a break portion BP and subsequent joining to make the axial flow smooth, the phase shift between the opposite ends 178au, 178bu, 178ad, and 178bd (90° in this example) may be substantially half that between the multiple (two in this example) helical blades 178a and 178b (180° in this example). This means that the downstream ends 178ad and 178bd are substantially at the midpoint between the upstream ends 178au and 178bu. Dividing the flows Ga and Gb of the two-component developer equally (into the flows Ga1 and Ga2 and the flows Gb1 and Gb2) and then joining the divided flows together (into the flow Ga2+Gb1 and the flow Ga1+Gb2) in this setting will ensure that the volume of developer transported is consistently uniform. The multi-start auger 178, however, may have any number of helical blades. If it has, for example, three helical blades 178a, 178b, and 178c, the phase shift between the helical blades 178a, 178b, and 178c may therefore be 120°, and the phase shift between the opposite upstream ends 178au, 178bu, and 178cu and downstream ends 178ad, 178bd, and 178cd in each break portion BP may be 60°. This further boosts the axial transport and agitating and mixing of the two-component developer, thereby contributing to further stabilizing the volume of developer transported.

The helical blade(s), moreover, may have any number of break portions BP at any point(s). In view of effective prevention of insufficient mixing of the two-component developer, the break portion(s) BP may be downstream of the developer inlet. In this region, the toner tends to be nonuniform because of the fresh replenishment toner that supplies there.

In view of the detection of toner density in its steady state after the two-component developer has been fully agitated and mixed, furthermore, the break portion(s) BP may be upstream of the toner density sensor S.

### Second Exemplary Embodiment

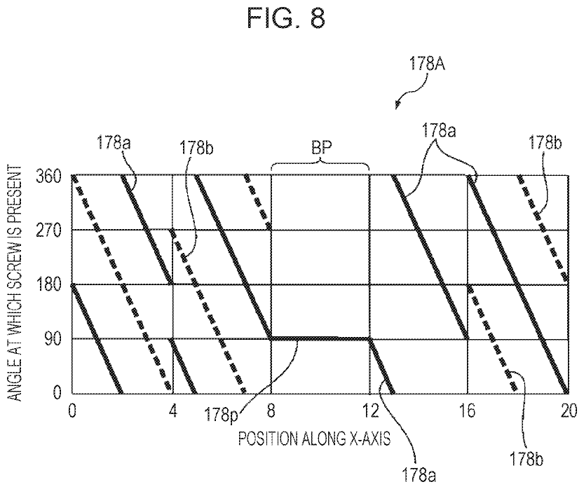

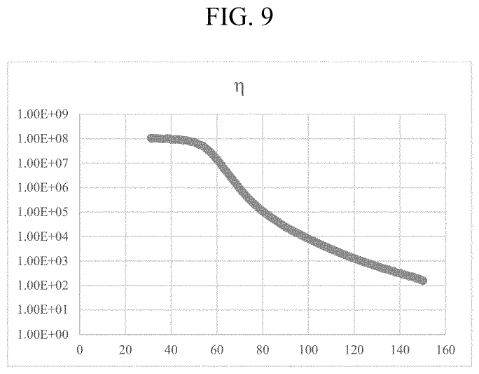

Next is described a transporter used in a second exemplary embodiment. As an example, the structure of an admix auger 178A is described with reference to FIG. 8. In comparison with that in the first exemplary embodiment, the admix auger 178A according to this exemplary embodiment has a agitating paddle. The paddle extends along the axis but not over the full length of the auger 178A. The admix auger 178A also differs from that in the first exemplary embodiment in the structure of the helical blades downstream of the paddle. In the following, elements having the same function as in the first exemplary embodiment are referenced by the same designators as in the first exemplary embodiment and not described in detail.

As schematically illustrated in FIG. 8, the admix auger 178A has a break portion BP. The break portion BP is axially at the point where the toner density sensor S is (see FIGS. 3 and 4). In this break portion BP, the admix auger 178A has a flat-plate paddle 178p that extends along the axis and projects radially. To be more specific, in FIG. 8, the section between X (8) and X (12) is a break portion BP, and a flat-plate paddle 178p extends over the axial section where this break portion BP lies.

The use of such a paddle 178p contributes to stable detection of the toner density by supporting supply the two-component developer to the detection surface of the toner density sensor S constantly.

When used with multiple helical blades 178a and 178b as described above, however, such a paddle 178p can cause the axial transport of the two-component developer not to be smooth because the helical blades occupy large a cross-sectional area (the cross-sectional area available for the two-component developer to pass through in the axial direction is narrower) downstream of the paddle 178p in comparison with one helical blade.

To counter this, the admix auger 178 has fewer helical blades 178b downstream of the paddle 178p.

To be more specific, as can be seen from the axial section between X (12) and X (16) in FIG. 8, the admix auger 178 has one helical blade 178 (only the helical blade 178a in this example) in the section immediately downstream of the paddle 178p. In other words, the helical blade 178b downstream of the paddle 178p, which extends between X (8) and X (12), is present only in the axial sections downstream of X (16).

This reduces the cross-sectional area occupied by the helical blades immediately downstream of the paddle 178p, thereby increasing the flow of the two-component developer (volume of developer transported in the axial direction) into the helical-blade zone past the paddle 178p. This allows the admix auger 178A to transfer the two-component developer in the axial direction from the paddle 178p to the helical blade 178a smoothly.

In the developer agitator-transporter 178 having such a structure, multiple helical blades 178a and 178b have a break portion BP. In the break portion BP, there is a phase shift between the opposite ends 178au and 178ad or 178bu and 178bd. The break portion BP improves the axial transport and agitating and mixing of the two-component developer by splitting/joining the developer.

Furthermore, there are fewer helical blades 178 immediately downstream of a agitating paddle 178p present in the break portion BP. This prevents the two-component developer from staying in the break portion BP too long.

The technical scope of the present disclosure is not limited to the foregoing description of exemplary embodiments. A wide variety of modifications and variations can be made within the scope of the disclosure, which is defined by the claims and their equivalents. For example, all of the above exemplary embodiments are about the configuration of a multi-start auger having break portion(s) BP applied to an admix auger 178, but in view of the improvement of axial transport and agitating and mixing, this configuration may naturally be applied to a supply auger 177 or may be applied to any other element that transports the developer while agitating it (e.g., a dispense auger installed in the path for replenishment toner to be supplied through). Each of the above exemplary embodiments may be implemented alone, but, naturally, two or more of them may be implemented in combination.

### EXAMPLES

The following describes examples of an exemplary embodiment of the present disclosure, but the exemplary embodiment of the present disclosure is not limited to these examples. In the following description, all “parts” and “%” are by mass unless stated otherwise.

The viscosity, highest-endothermic-peak temperature, and absorbance values at certain wavenumbers of the toners are measured as described above.

### Developers A1 to A13 and B1 to B3

### Preparation of Liquid Dispersions of Styrene-Acrylic Resin Particles

### Production of Resin-Particle Dispersion (1)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1 part

A solution of 4 parts of an anionic surfactant (Dowfax, Dow Chemical) in 550 parts of ion exchange water is put into a flask, and a liquid mixture of the above raw materials is added to cause emulsification. While the emulsified liquid is agitated slowly for 10 minutes, a solution of 6 parts of ammonium persulfate in 50 parts of ion exchange water is added. The system is then purged with plenty of nitrogen and heated in an oil bath until the temperature inside reaches 75° C., and polymerization is allowed to proceed for 30 minutes.

Then,

Styrene: 110 parts

n-Butyl acrylate: 50 parts

β-Carboxyethyl acrylate: 5 parts

1,10-Decanediol diacrylate: 2.5 parts

Dodecanethiol: 2 parts

a liquid mixture of the above raw materials is emulsified, the emulsified liquid is added to the flask over 120 minutes, and emulsification polymerization is continued for another 4 hours. This gives a resin-particle dispersion as a liquid dispersion of resin particles having a weight-average molecular weight of 32,000, a glass transition temperature of 53° C., and a volume-average diameter of 240 nm. To this resin-particle dispersion, ion exchange water is added to adjust the solids content to 20% by mass. The resulting dispersion is resin-particle dispersion (1).

### Production of Resin-Particle Dispersion (2)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A solution of 4 parts of an anionic surfactant (Dowfax, Dow Chemical) in 550 parts of ion exchange water is put into a flask, and a liquid mixture of the above raw materials is added to cause emulsification. While the emulsified liquid is agitated slowly for 10 minutes, a solution of 6 parts of ammonium persulfate in 50 parts of ion exchange water is added. The system is then purged with plenty of nitrogen and heated in an oil bath until the temperature inside reaches 75° C., and polymerization is allowed to proceed for 30 minutes.

Then,

Styrene: 110 parts

n-Butyl acrylate: 50 parts

β-Carboxyethyl acrylate: 5 parts

1,10-Decanediol diacrylate: 2.5 parts

Dodecanethiol: 2.5 parts

a liquid mixture of the above raw materials is emulsified, the emulsified liquid is added to the flask over 120 minutes, and emulsification polymerization is continued for another 4 hours. This gives a resin-particle dispersion as a liquid dispersion of resin particles having a weight-average molecular weight of 30,000, a glass transition temperature of 53° C., and a volume-average diameter of 220 nm. To this resin-particle dispersion, ion exchange water is added to adjust the solids content to 20% by mass. The resulting dispersion is resin-particle dispersion (2).

### Production of Resin-Particle Dispersion (3)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A solution of 4 parts of an anionic surfactant (Dowfax, Dow Chemical) in 550 parts of ion exchange water is put into a flask, and a liquid mixture of the above raw materials is added to cause emulsification. While the emulsified liquid is agitated slowly for 10 minutes, a solution of 7 parts of ammonium persulfate in 50 parts of ion exchange water is added. The system is then purged with plenty of nitrogen and heated in an oil bath until the temperature inside reaches 80° C., and polymerization is allowed to proceed for 30 minutes.

Next,

Styrene: 110 parts

n-Butyl acrylate: 50 parts

β-Carboxyethyl acrylate: 5 parts

1,10-Decanediol diacrylate: 2.5 parts

Dodecanethiol: 3.0 parts

a liquid mixture of the above raw materials is emulsified, the emulsified liquid is added to the flask over 120 minutes, and emulsification polymerization is continued for another 4 hours. This gives a resin-particle dispersion as a liquid dispersion of resin particles having a weight-average molecular weight of 28,000, a glass transition temperature of 53° C., and a volume-average diameter of 230 nm. To this resin-particle dispersion, ion exchange water is added to adjust the solids content to 20% by mass. The Resulting dispersion is resin-particle dispersion (3).

### Production of Resin-Particle Dispersion (4)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 2.0 parts

A solution of 4 parts of an anionic surfactant (Dowfax, Dow Chemical) in 550 parts of ion exchange water is put into a flask, and a liquid mixture of the above raw materials is added to cause emulsification. While the emulsified liquid is agitated slowly for 10 minutes, a solution of 7.5 parts of ammonium persulfate in 50 parts of ion exchange water is added. The system is then purged with plenty of nitrogen and heated in an oil bath until the temperature inside reaches 85° C., and polymerization is allowed to proceed for 30 minutes.

Then,

Styrene: 110 parts

n-Butyl acrylate: 50 parts

β-Carboxyethyl acrylate: 5 parts

1,10-Decanediol diacrylate: 2.5 parts

Dodecanethiol: 3.5 parts

a liquid mixture of the above raw materials is added to cause emulsification, the emulsified liquid is added to the flask over 120 minutes, and emulsification polymerization is continued for another 4 hours. This gives a resin-particle dispersion as a liquid dispersion of resin particles having a weight-average molecular weight of 26,500, a glass transition temperature of 53° C., and a volume-average diameter of 210 nm. To this resin-particle dispersion, ion exchange water is added to adjust the solids content to 20% by mass. The resulting dispersion is resin-particle dispersion (4).

### Production of Resin-Particle Dispersion (5)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 0.8

A solution of 4 parts of an anionic surfactant (Dowfax, Dow Chemical) in 550 parts of ion exchange water is put into a flask, and a liquid mixture of the above raw materials is added to cause emulsification. While the emulsified liquid is agitated slowly for 10 minutes, a solution of 5.5 parts of ammonium persulfate in 50 parts of ion exchange water is added. The system is then purged with plenty of nitrogen and heated in an oil bath until the temperature inside reaches 85° C., and polymerization is allowed to proceed for 30 minutes.

Then,

Styrene: 110 parts

n-Butyl acrylate: 50 parts

β-Carboxyethyl acrylate: 5 parts

1,10-Decanediol diacrylate: 2.5 parts

Dodecanethiol: 1.7 parts

a liquid mixture of the above raw materials is added to cause emulsification, the emulsified liquid is added to the flask over 120 minutes, and emulsification polymerization is continued for another 4 hours. This gives a resin-particle dispersion as a liquid dispersion of resin particles having a weight-average molecular weight of 36,000, a glass transition temperature of 53° C., and a volume-average diameter of 260 nm. To this resin-particle dispersion, ion exchange water is added to adjust the solids content to 20% by mass. The resulting dispersion is resin-particle dispersion (5).

### Preparation of Liquid Dispersion of Magenta-Colored Particles

C.I. Pigment Red 122: 50 parts
Ionic surfactant Neogen RK (DKS Co., Ltd.): 5 parts
Ion exchange water: 220 parts

These ingredients are mixed together, and the resulting mixture is processed using an Ultimaizer (Sugino Machine Ltd.) for 10 minutes at 240 MPa to give a liquid dispersion of magenta-colored particles (solids concentration: 20%).

### Preparation of Release-Agent-Particle Dispersion (1)

Ester wax (WEP-2, NOF Corp.): 100 parts
Anionic surfactant (Neogen RK, DKS Co., Ltd.): 2.5 parts
Ion exchange water: 250 parts

These materials are mixed together and heated to 120° C. After dispersion using a homogenizer (IKA ULTRA-TURRAX T50), the mixture is subjected to further dispersion using a Manton-Gaulin high-pressure homogenizer (Gaulin). This gives release-agent-particle dispersion (1) as a liquid dispersion of release-agent particles having a volume-average diameter of 330 nm (solids content, 29.1%).

### Preparation of Release-Agent-Particle Dispersion (2)

Fischer-Tropsch wax (HNP-9, Nippon Seiro Co., Ltd.): 100 parts
Anionic surfactant (Neogen RK, DKS Co., Ltd.): 2.5 parts
Ion exchange water: 250 parts

These materials are mixed together and heated to 120° C. After dispersion using a homogenizer (IKA ULTRA-TURRAX T50), the mixture is subjected to further dispersion using a Manton-Gaulin high-pressure homogenizer (Gaulin). This gives release-agent-particle dispersion (2) as a liquid dispersion of release-agent particles having a volume-average diameter of 340 nm (solids content, 29.2%).

### Preparation of Release-Agent-Particle Dispersion (3)

Paraffin wax (FNP0090, Nippon Seiro Co., Ltd.): 100 parts
Anionic surfactant (Neogen RK, DKS Co., Ltd.): 2.5 parts
Ion exchange water: 250 parts

These materials are mixed together and heated to 120° C. After dispersion using a homogenizer (IKA ULTRA-TURRAX T50), the mixture is subjected to further dispersion using a Manton-Gaulin high-pressure homogenizer (Gaulin). This gives release-agent-particle dispersion (3) as a liquid dispersion of release-agent particles having a volume-average diameter of 360 nm (solids content, 29.0%).

### Preparation of Release-Agent-Particle Dispersion (4)

Polyethylene wax (Polywax 725, Toyo ADL Corp.): 100 parts
Anionic surfactant (Neogen RK, DKS Co., Ltd.): 2.5 parts
Ion exchange water: 250 parts

These materials are mixed together and heated to 100° C. After dispersion using a homogenizer (IKA ULTRA-TURRAX T50), the mixture is subjected to further dispersion using a Manton-Gaulin high-pressure homogenizer (Gaulin). This gives release-agent-particle dispersion (4) as a liquid dispersion of release-agent particles having a volume-average diameter of 370 nm (solids content, 29.3%).

### Process for the Production of Toner A1

Ion exchange water: 400 parts

Resin-particle dispersion (1): 200 parts

Liquid dispersion of magenta-colored particles: 40 parts

Release-agent-particle dispersion (2): 12 parts

Release-agent-particle dispersion (3): 24 parts

These ingredients are put into a reactor equipped with a thermometer, a pH meter, and an agitator and are agitated for 30 minutes at a constant rate of 150 rpm and a constant temperature of 30° C. while the temperature is controlled from the outside using a mantle heater.

While the ingredients are dispersed using a homogenizer (ULTRA-TURRAX T50, IKA Japan K.K.), a PAC aqueous solution, prepared by dissolving 2.1 parts of polyaluminum chloride (PAC, Oji Paper Co., Ltd.; 30% powder) in 100 parts of ion exchange water, is added. Then the temperature is increased to 50° C., and the particle diameter is measured using a Coulter Multisizer II (aperture size, 50 μm; Coulter) to ensure that the volume-average particle diameter is 5.0 μm. Then another 115 parts of resin-particle dispersion (1) is added to attach resin particles (shell structure) to the surface of the aggregates.

Then 20 parts of a 10% by mass aqueous solution of a NTA (nitrilotriacetic acid) metal salt (CHELEST 70, Chelest Corp.) is added, and the pH is adjusted to 9.0 with a 1 N aqueous solution of sodium hydroxide. Then the temperature is increased to 91° C. at an elevation rate of 0.05° C./min and maintained at 91° C. for 3 hours, and the resulting toner slurry is cooled to 85° C. and maintained for 1 hour and then cooled to 25° C. The resulting magenta toner is washed by repeated dispersion in ion exchange water and filtration until the filtrate's electrical conductivity is 20 μS/cm or less. The washed toner is vacuum-dried for 5 hours in an oven at 40° C. to give toner particles.

One hundred parts of the toner particles is mixed with 1.5 parts of hydrophobic silica (RY50, Nippon Aerosil Co., Ltd.) and 1.0 part of hydrophobic titanium oxide (T805, Nippon Aerosil Co., Ltd.) for 30 seconds at 10,000 rpm using a sample mill. The mixture is then sieved through a 45-μm-mesh vibrating sieve. The resulting material is toner A1 (toner A1 for electrostatic-charge-image development). The volume-average particle diameter of toner A1 is 5.7 μm.

### Production of Developer A1

Eight parts of toner A1 and 92 parts of a carrier are mixed using a V-blender. The resulting mixture is developer A1 (electrostatic charge image developer A1).

The carrier has an average particle diameter of 35 μm and is produced by mixing 100 parts of Mn—Sr cores, 7.5 parts of a silicone resin (Dow Corning Toray SR2411), and 100 parts of toluene, removing the solvent by distillation, and curing the resin by stirring the residue at 150° C. for 1 hour.

### Production of Developers A2 to A13 and B1 and B2

Magenta toners A2 to A13 and B1 and B2 are each obtained in the same way as toner A1 except that parameter changes are made as in Table 1 regarding the resin-particle dispersion, the release-agent-particle dispersions, the amount of flocculant, the temperature at which coalescence is performed, the temperature at which the toner slurry is maintained, and the duration for which the toner slurry is maintained at that temperature.

Then electrostatic charge image developers A2 to A13 and B1 and B2 are each produced in the same way as developer A1 except that the respective toners are used.

### Production of Developer B3

Magenta toner B3 is obtained in the same way as toner A1 except that parameter changes are made as in Table 1 regarding the resin-particle dispersion, the release-agent-particle dispersions, the amount of flocculant, the temperature at which coalescence is performed, the temperature at which the toner slurry is maintained, and the duration for which the toner slurry is maintained at that temperature.

Then electrostatic charge image developer B3 is produced in the same way as developer A1 except that the resulting toner is used.

TABLE 1

| | | | | (Inη (T2) − | (Inη (T0) − | Toner's | | | |
|---|---|---|---|---|---|---|---|---|---|
| | | | | Inη (T3))/ | Inη (T1))/ | highest- | | | |
| | | | | (T2 − T3) − | (T0 − T1) − | endothermic- | | | |
| | (Inη (T1) − | (Inη (T2) − | (Inη (T0) − | (Inη (T1) − | (Inη (T1) − | peak | | | Resin- |
| | Inη (T2))/ | Inη (T3))/ | Inη (T1))/ | Inη (T2))/ | Inη (T2))/ | temperature | | | particle |
| Toner | (T1 − T2) | (T2 − T3) | (T0 − T1) | (T1 − T2) | (T1 − T2) | (° C.) | a/b | c/d | dispersion |
| A1 | −0.215 | −0.090 | −0.110 | 0.125 | 0.105 | 85 | 5.0 | 2.9 | (3) |
| A2 | −0.168 | −0.080 | −0.085 | 0.088 | 0.083 | 85 | 5.1 | 2.5 | (2) |
| A3 | −0.143 | −0.100 | −0.078 | 0.043 | 0.065 | 85 | 4.9 | 2.6 | (1) |
| A4 | −0.213 | −0.090 | −0.106 | 0.123 | 0.107 | 85 | 5.0 | 2.8 | (3) |
| A5 | −0.214 | −0.100 | −0.110 | 0.114 | 0.104 | 85 | 5.1 | 2.4 | (3) |
| A6 | −0.154 | −0.135 | −0.077 | 0.019 | 0.077 | 70 | 5.1 | 2.6 | (1) |
| A7 | −0.153 | −0.133 | −0.080 | 0.020 | 0.073 | 100 | 4.9 | 2.8 | (1) |
| A8 | −0.155 | −0.141 | −0.083 | 0.014 | 0.072 | 63 | 5.0 | 2.5 | (1) |
| A9 | −0.156 | −0.136 | −0.079 | 0.020 | 0.077 | 102 | 5.1 | 2.9 | (1) |
| A10 | −0.152 | −0.141 | −0.073 | 0.011 | 0.079 | 85 | 1.5 | 1.3 | (1) |
| A11 | −0.153 | −0.142 | −0.071 | 0.011 | 0.082 | 85 | 7.2 | 3.5 | (1) |
| A12 | −0.155 | −0.135 | −0.075 | 0.020 | 0.080 | 85 | 8.5 | 4.5 | (1) |
| A13 | −0.154 | −0.134 | −0.078 | 0.020 | 0.076 | 85 | 0.7 | 0.6 | (1) |
| B1 | −0.129 | −0.090 | −0.068 | 0.039 | 0.061 | 85 | 5.3 | 2.9 | (5) |
| B2 | −0.215 | −0.155 | −0.113 | 0.060 | 0.102 | 85 | 5.3 | 2.9 | (3) |
| B3 | −0.180 | −0.186 | −0.109 | −0.006 | 0.071 | 85 | 5.3 | 2.9 | (4) |

| | First release- | | Second release- | | Toner production parameters | | | |
|---|---|---|---|---|---|---|---|---|
| | agent-particle | | agent-particle | | Amount of | Coalescence | Maintenance | Duration of |
| | dispersion | | dispersion | | flocculant | temperature | temperature | maintenance |
| Toner | Type | Parts | Type | Parts | (parts) | (° C.) | (° C.) | (hours) |
| A1 | (2) | 12 | (3) | 24 | 2.1 | 91 | 85 | 1 |
| A2 | (2) | 12 | (3) | 24 | 2.1 | 92 | 85 | 1 |
| A3 | (2) | 12 | (3) | 24 | 2.1 | 93 | 85 | 1 |
| A4 | (2) | 12 | (3) | 24 | 1.9 | 92 | 85 | 1 |
| A5 | (2) | 12 | (3) | 24 | 1.7 | 91 | 85 | 1 |
| A6 | (1) | 12 | (2) | 24 | 1.7 | 77 | 70 | 1 |
| A7 | (3) | 12 | (4) | 24 | 1.7 | 108 | 95 | 1 |
| A8 | (1) | 28.8 | (2) | 7.2 | 1.7 | 70 | 65 | 1 |
| A9 | (3) | 7.2 | (4) | 28.8 | 1.7 | 108 | 95 | 1 |
| A10 | (2) | 12 | (3) | 24 | 1.7 | 91 | 85 | 0.5 |
| A11 | (2) | 12 | (3) | 24 | 1.7 | 92 | 85 | 2 |
| A12 | (2) | 12 | (3) | 24 | 1.7 | 93 | 85 | 3 |
| A13 | (2) | 12 | (3) | 24 | 1.7 | 92 | 85 | 0.25 |
| B1 | (2) | 12 | (3) | 24 | 2.1 | 91 | 85 | 1 |
| B2 | (2) | 12 | (3) | 24 | 1.5 | 93 | 85 | 1 |
| B3 | (2) | 12 | (3) | 24 | 2.1 | 93 | 85 | 1 |

### Transporters S1 and S0

### Preparation of Transporter S1

Transporter S1 is prepared as a transporter that transports developer while agitating it. Transporter S1 has two helical blades with a phase shift of 180° therebetween (so-called PS auger). Each helical blade has three break zones that make it discontinuous along the axis. In a subset of the break zones (each of the two located furthest downstream), a flat-plate paddle extends along the axis and projects radially. The percentage of the axial length of the section of the rotary shaft with the helical blades therearound to the whole axial length of the rotary shaft is 80%.

Like those illustrated in FIG. 8, the helical blades occupy a smaller cross-sectional area in the sections immediately downstream of the flat-plate paddles than in the other sections.

The rotary shaft of transporter S1 is a resin shaft, the helical blades are resin blades made from a thermosetting resin, and the paddles are resin.

### Preparation of Transporter S0

Transporter S0 is prepared as a transporter that agitates and transports developer. Transporter S0 has one helical blade without a break zone that makes the helical blade discontinuous along the axis. Since the helical blade has no break zone, the percentage of the axial length of the rotary shaft with the helical blade therearound to the whole axial length of the rotary shaft is 100%.

Except that the number of helical blades is one, that the helical blade has no break zone that makes it discontinuous along the axis, and that there is no radially projecting flat-plate paddle, transporter S0 is equivalent to transporter S1.

### Examples 101 to 113 and Comparative Examples 101 to 113, 201 to 203, and 301 to 303

A commercially available electrophotographic duplicator (DOCUCENTRE COLOR 450, manufactured by Fuji Xerox Co., Ltd.) is used as a test apparatus with the developer specified in Table 2 loaded into its developing device and the transporter specified in Table 2 attached.

### Evaluation

### Test for Fog on the Image

Each Example or Comparative Example is tested for fog as follows.

Using the test apparatus, a 15% coverage sample image (sample image with an area coverage of 15%; text with one-inch solid squares at the top, bottom, left edge, right edge, and center of the page) is printed on sets of 2000 sheets of P paper under high-temperature and high-humidity conditions (28° C. and 85% RH) until a print volume (pv) of 20000. Then the quality of the sample image is graded in accordance with the following criteria.

A: A visual inspection finds no fog.

B: A visual inspection finds very slight fog, but the image quality is acceptable.

C: A visual inspection finds minor fog or a fog considered unacceptable.

### Test for Leaking Toner on the Image

Each Example or Comparative Example is tested for leaking toner as follows.

Using the test apparatus, an image with an area density of 40% is printed continuously on 3,000 sheets of A4-size paper at a rate of 125 sheets/min, and then text that makes an area coverage of 2% is printed on 10 sheets of A4-size paper, both under high-temperature and high-humidity conditions (28° C. and 85% RH). The last of the ten sheets with printed text is visually inspected for leaking toner, and the quality is graded in accordance with the following criteria.

A: The image is of very good quality. No toner blot is found.

B: One to nine toner blots are observed, but the image quality is acceptable.

C: Ten or more toner blots are observed.

### Test for Color Spots on the Image

Each Example or Comparative Example is tested for color spots as follows.

Using the test apparatus, a 50% halftone image is printed on 2,000 sheets under low-temperature and low-humidity conditions (10° C. and 10% RH). The charging voltage is set to +600 V. In the next morning, a sheet of white paper is transported in the apparatus, and color spots on the sheet are counted. Grading is performed in accordance with the following criteria.

A: There is no color spot.

B: One to five color spots are observed.

C: Six or more color spots are observed.

TABLE 2

| | | | | | | | <Evaluation> | |
|---|---|---|---|---|---|---|---|---|
| | | | | <Evaluation> | | | Leaking | Color |
| | | | | Fog (high- | Developer | | toner (high- | specks (low- |
| | Transporter | | | temperature | | Carrier | temperature | temperature |
| | | Number | Number | and high- | | particle | and high- | and low- |
| | | of helical | of break | humidity | | diameter | humidity | humidity |
| | Type | blades | regions | conditions) | Type | [μm] | conditions) | conditions) |
| Example 101 | S1 | 2 | 3 | A | A1 | 35 | A | A |
| Example 102 | | | | | A2 | 35 | A | A |
| Example 103 | | | | | A3 | 35 | A | A |
| Example 104 | | | | | A4 | 35 | A | A |
| Example 105 | | | | | A5 | 35 | A | A |
| Example 106 | | | | | A6 | 35 | A | A |
| Example 107 | | | | | A7 | 35 | A | A |
| Example 108 | | | | | A8 | 35 | A | A |
| Example 109 | | | | | A9 | 35 | A | A |
| Example 110 | | | | | A10 | 35 | A | A |
| Example 111 | | | | | A11 | 35 | A | A |
| Example 112 | | | | | A12 | 35 | A | A |
| Example 113 | | | | | A13 | 35 | A | A |
| Comparative Example 101 | S0 | 1 | 0 | C | A1 | 35 | A | A |
| Comparative Example 102 | | | | | A2 | 35 | A | A |
| Comparative Example 103 | | | | | A3 | 35 | A | A |
| Comparative Example 104 | | | | | A4 | 35 | A | A |
| Comparative Example 105 | | | | | A5 | 35 | A | A |
| Comparative Example 106 | | | | | A6 | 35 | A | A |
| Comparative Example 107 | | | | | A7 | 35 | A | A |
| Comparative Example 108 | | | | | A8 | 35 | A | A |
| Comparative Example 109 | | | | | A9 | 35 | A | A |
| Comparative Example 110 | | | | | A10 | 35 | A | A |
| Comparative Example 111 | | | | | A11 | 35 | A | A |
| Comparative Example 112 | | | | | A12 | 35 | A | A |
| Comparative Example 113 | | | | | A13 | 35 | A | A |
| Comparative Example 201 | S1 | 2 | 3 | A | B1 | 35 | A | C |
| Comparative Example 202 | | | | | B2 | 35 | C | A |
| Comparative Example 203 | | | | | B3 | 35 | C | B |
| Comparative Example 301 | S0 | 1 | 0 | C | B1 | 35 | A | A |
| Comparative Example 302 | | | | | B2 | 35 | A | A |
| Comparative Example 303 | | | | | B3 | 35 | A | A |

As can be seen from the table, the image forming apparatuses of Examples, which use toners that satisfy the relations of the (ln η(T1)−ln η(T2))/(T1−T2) being −0.14 or less, the (ln η(T2)−ln η(T3))/(T2−T3) being −0.15 or more, and the (ln η(T2)−ln η(T3))/(T2−T3) being greater than the (ln η(T1)−ln η(T2))/(T1−T2), reduces leaking toner, color spots, and fog on the image in comparison with those of Comparative Examples, which use toners that fail to satisfy at least one of these relations.

### Developers A101 to A113 and B101 to B103

### Preparation of Liquid Dispersions of Amorphous Polyester Resin Particles

### Production of Resin-Particle Dispersion (101)

To a dried three-neck flask are added 60 parts of dimethyl terephthalate, 74 parts of dimethyl fumarate, 30 parts of dodecenylsuccinic anhydride, 22 parts of trimellitic acid, 138 parts of propylene glycol, and 0.3 parts of dibutyltin oxide. In a nitrogen atmosphere, the reaction is allowed to proceed for 3 hours at 185° C. while the water resulting from the reaction is removed out of the system. Then the temperature is increased to 240° C. while the pressure is reduced gradually. After another 4 hours of reaction, the system is cooled. The product is amorphous polyester resin (101) and has a weight-average molecular weight of 39,000.

After the removal of any precipitate, 200 parts of amorphous polyester resin (101) is added to a separable flask together with 100 parts of methyl ethyl ketone, 35 parts of isopropyl alcohol, and 7.0 parts of a 10% by mass aqueous solution of ammonia. The materials are mixed thoroughly to dissolve the resin, and then ion exchange water is added dropwise using a delivery pump at a rate of 8 g/min while the solution is heated and agitated at 40° C. After the solution becomes uniformly turbid, the delivery of ion exchange water is continued at an increased rate of 15 g/min to induce phase inversion and terminated after 580 parts of water has been added. Then the solvents are removed under reduced pressure. The resulting liquid is liquid dispersion (101) of amorphous polyester resin particles (resin-particle dispersion (101)). The volume-average diameter and solids concentration of the resulting polyester resin particles are 170 nm and 35%, respectively.

### Preparation of Resin-Particle Dispersions (102) to (105)

Resin-particle dispersions (102) to (105) are obtained in the same way as resin-particle dispersion (101) except that the polymerization is performed under the conditions specified in Table 3.

TABLE 3

| | Resin's | Polyester resin's |
|---|---|---|
| | durations of | weight-average |
| | polymerization | molecular weight |
| Dispersion (101) of amorphous | 3 hours at 185° C., | 39,000 |
| polyester resin particles | 4 hours at 240° C. | |
| Dispersion (102) of amorphous | 2.5 hours at 185° C., | 37,000 |
| polyester resin particles | 3.5 hours at 240° C. | |
| Dispersion (103) of amorphous | 2 hours at 185° C., | 35,000 |
| polyester resin particles | 3 hours at 240° C. | |
| Dispersion (104) of amorphous | 1.5 hours at 185° C., | 33,000 |
| polyester resin particles | 2.5 hours at 240° C. | |
| Dispersion (105) of amorphous | 4 hours at 185° C., | 43,000 |
| polyester resin particles | 5 hours at 240° C. | |

### Process for the Production of Toner A101

Ion exchange water: 400 parts

Liquid dispersion (103) of amorphous polyester resin particles: 200 parts

Liquid dispersion of magenta-colored particles: 40 parts

Release-agent-particle dispersion (2): 12 parts

Release-agent-particle dispersion (3): 24 parts

These ingredients are put into a reactor equipped with a thermometer, a pH meter, and an agitator and are agitated for 30 minutes at a constant rate of 150 rpm and a constant temperature of 30° C. while the temperature is controlled from the outside using a mantle heater.

While the ingredients are dispersed using a homogenizer (ULTRA-TURRAX T50, IKA Japan K.K.), a PAC aqueous solution, prepared by dissolving 2.1 parts of polyaluminum chloride (PAC, Oji Paper Co., Ltd.; 30% powder) in 100 parts of ion exchange water, is added. Then the temperature is increased to 50° C., and the particle diameter is measured using a Coulter Multisizer II (aperture size, 50 μm; Coulter) to ensure that the volume-average particle diameter is 4.9 μm. Then another 115 parts of liquid dispersion (101) of amorphous polyester resin particles is added to attach resin particles (shell structure) to the surface of the aggregates.

Then 20 parts of a 10% by mass aqueous solution of a NTA (nitrilotriacetic acid) metal salt (CHELEST 70, Chelest Corp.) is added, and the pH is adjusted to 9.0 with a 1 N aqueous solution of sodium hydroxide. Then the temperature is increased to 91° C. at an elevation rate of 0.05° C./min and maintained at 91° C. for 3 hours, and the resulting toner slurry is cooled to 85° C. and maintained for 1 hour and then cooled to 25° C. The resulting magenta toner is washed by repeated dispersion in ion exchange water and filtration until the filtrate's electrical conductivity is 20 μS/cm or less. The washed toner is vacuum-dried for 5 hours in an oven at 40° C. to give toner particles.

One hundred parts of the toner particles is mixed with 1.5 parts of hydrophobic silica (RY50, Nippon Aerosil Co., Ltd.) and 1.0 part of hydrophobic titanium oxide (T805, Nippon Aerosil Co., Ltd.) for 30 seconds at 10,000 rpm using a sample mill. The mixture is then sieved through a 45-μm-mesh vibrating sieve. The resulting material is toner A101 (toner A101 for electrostatic-charge-image development).

The volume-average particle diameter of toner A101 is 5.8 μm. Production of Developer A101

Eight parts of toner A101 and 92 parts of a carrier are mixed using a V-blender. The resulting mixture is developer A101 (electrostatic charge image developer A101).

### Production of Developers A102 to A113 and B101 and B102

Magenta toners A102 to A113 and B101 and B102 are each obtained in the same way as toner A101 except that parameter changes are made as in Table 4 regarding the resin-particle dispersion, the release-agent-particle dispersions, the amount of flocculant, the temperature at which coalescence is performed, the temperature at which the toner slurry is maintained, and the duration for which the toner slurry is maintained at that temperature.

Then electrostatic charge image developers A102 to A113 and B101 and B102 are each produced in the same way as developer A101 except that the respective toners are used. Production of Developer B103

Magenta toner B103 is obtained in the same way as toner A101 except that parameter changes are made as in Table 4 regarding the resin-particle dispersion, the release-agent-particle dispersions, the amount of flocculant, the temperature at which coalescence is performed, the temperature at which the toner slurry is maintained, and the duration for which the toner slurry is maintained at that temperature.

Then electrostatic charge image developer B103 is produced in the same way as developer A101 except that the resulting toner is used.

TABLE 4

| | | | | (Inη (T2) − | (Inη (T0) − | Toner's | | | | |
|---|---|---|---|---|---|---|---|---|---|---|
| | | | | Inη (T3))/ | Inη (T1))/ | highest- | | | | |
| | | | | (T2 − T3) − | (T0 − T1) − | endothermic- | | | | |
| | (Inη (T1) − | (Inη (T2) − | (Inη (T0) − | (Inη (T1) − | (Inη (T1) − | peak | | | | |
| | Inη (T2))/ | Inη (T3))/ | Inη (T1))/ | Inη (T2))/ | Inη (T2))/ | temperature | | | 1,500 cm⁻¹/ | 820 cm⁻¹/ |
| Toner | (T1 − T2) | (T2 − T3) | (T0 − T1) | (T1 − T2) | (T1 − T2) | (° C.) | a/b | c/d | 720 cm⁻¹ | 720 cm⁻¹ |
| A101 | −0.220 | −0.110 | −0.100 | 0.110 | 0.120 | 85 | 5.2 | 2.7 | 0.30 | 0.16 |
| A102 | −0.163 | −0.070 | −0.080 | 0.093 | 0.083 | 85 | 4.9 | 2.3 | 0.31 | 0.15 |
| A103 | −0.141 | −0.100 | −0.065 | 0.041 | 0.076 | 85 | 4.8 | 2.7 | 0.29 | 0.17 |
| A104 | −0.222 | −0.080 | −0.111 | 0.142 | 0.111 | 85 | 5.2 | 2.7 | 0.33 | 0.16 |
| A105 | −0.211 | −0.110 | −0.101 | 0.101 | 0.110 | 85 | 5.0 | 2.5 | 0.34 | 0.17 |
| A106 | −0.156 | −0.131 | −0.075 | 0.025 | 0.081 | 70 | 4.9 | 2.4 | 0.30 | 0.16 |
| A107 | −0.154 | −0.135 | −0.072 | 0.019 | 0.082 | 100 | 4.7 | 2.9 | 0.29 | 0.15 |
| A108 | −0.155 | −0.139 | −0.079 | 0.016 | 0.076 | 85 | 1.6 | 1.4 | 0.33 | 0.17 |
| A109 | −0.154 | −0.141 | −0.077 | 0.013 | 0.077 | 85 | 7.1 | 3.3 | 0.29 | 0.18 |
| A110 | −0.151 | −0.136 | −0.072 | 0.015 | 0.079 | 63 | 5.2 | 2.9 | 0.27 | 0.16 |
| A111 | −0.153 | −0.140 | −0.081 | 0.013 | 0.072 | 102 | 5.1 | 2.5 | 0.34 | 0.17 |
| A112 | −0.152 | −0.133 | −0.080 | 0.019 | 0.072 | 85 | 8.6 | 4.6 | 0.33 | 0.16 |
| A113 | −0.151 | −0.133 | −0.071 | 0.018 | 0.080 | 85 | 0.8 | 0.5 | 0.31 | 0.15 |
| B101 | −0.127 | −0.110 | −0.055 | 0.017 | 0.072 | 85 | 5.0 | 2.7 | 0.34 | 0.16 |
| B102 | −0.221 | −0.160 | −0.132 | 0.061 | 0.089 | 85 | 5.1 | 2.8 | 0.28 | 0.18 |
| B103 | −0.203 | −0.224 | −0.119 | −0.021 | 0.084 | 85 | 5.3 | 3.0 | 0.36 | 0.17 |

| | | First release- | | Second release- | | Toner production parameters | | | |
|---|---|---|---|---|---|---|---|---|---|
| | Resin- | agent-particle | | agent-particle | | Amount of | Coalescence | Maintenance | Duration of |
| | particle | dispersion | | dispersion | | flocculant | temperature | temperature | maintenance |
| Toner | dispersion | Type | Parts | Type | Parts | (parts) | (° C.) | (° C.) | (hours) |
| A101 | (103) | (2) | 12 | (3) | 24 | 2.1 | 91 | 85 | 1 |
| A102 | (102) | (2) | 12 | (3) | 24 | 2.1 | 92 | 85 | 1 |
| A103 | (101) | (2) | 12 | (3) | 24 | 2.1 | 93 | 85 | 1 |
| A104 | (103) | (2) | 12 | (3) | 24 | 1.9 | 92 | 85 | 1 |
| A105 | (103) | (2) | 12 | (3) | 24 | 1.7 | 91 | 85 | 1 |
| A106 | (101) | (1) | 12 | (2) | 24 | 1.7 | 77 | 70 | 1 |
| A107 | (101) | (3) | 12 | (4) | 24 | 1.7 | 108 | 95 | 1 |
| A108 | (101) | (2) | 12 | (3) | 24 | 1.7 | 91 | 85 | 0.5 |
| A109 | (101) | (2) | 12 | (3) | 24 | 1.7 | 92 | 85 | 2 |
| A110 | (103) | (1) | 28.8 | (2) | 7.2 | 1.7 | 70 | 65 | 1 |
| A111 | (103) | (3) | 7.2 | (4) | 28.8 | 1.7 | 108 | 95 | 1 |
| A112 | (103) | (2) | 12 | (3) | 24 | 1.7 | 93 | 85 | 3 |
| A113 | (103) | (2) | 12 | (3) | 24 | 1.7 | 92 | 85 | 0.25 |
| B101 | (105) | (2) | 12 | (3) | 24 | 2.1 | 91 | 85 | 1 |
| B102 | (103) | (2) | 12 | (3) | 24 | 1.5 | 93 | 85 | 1 |
| B103 | (104) | (2) | 12 | (3) | 24 | 1.5 | 93 | 85 | 1 |

### Examples 1101 to 1113 and Comparative Examples 1101 to 1113, 2101 to 2103, and 3101 to 3103

A commercially available electrophotographic duplicator (DOCUCENTRE COLOR 450, manufactured by Fuji Xerox Co., Ltd.) is used as a test apparatus with the developer specified in Table 5 loaded into its developing module and the developing roller specified in Table 5 attached.

### Evaluation

Tests regarding <consistency in the volume of toner transported> and <consistency in image quality> are performed under high-temperature and high-humidity or low-temperature and low-humidity conditions in the same way as above. The results are presented in Table 5.

TABLE 5

| | | | | | | | <Evaluation> | |
|---|---|---|---|---|---|---|---|---|
| | | | | <Evaluation> | | | Leaking | Color |
| | | | | Fog (high- | Developer | | toner (high- | specks (low- |
| | Transporter | | | temperature | | Carrier | temperature | temperature |
| | | Number | Number | and high- | | particle | and high- | and low- |
| | | of helical | of break | humidity | | diameter | humidity | humidity |
| | Type | blades | regions | conditions) | Type | [μm] | conditions) | conditions) |
| Example 1101 | S1 | 2 | 3 | A | A101 | 35 | A | A |
| Example 1102 | | | | | A102 | 35 | A | A |
| Example 1103 | | | | | A103 | 35 | A | A |
| Example 1104 | | | | | A104 | 35 | A | A |
| Example 1105 | | | | | A105 | 35 | A | A |
| Example 1106 | | | | | A106 | 35 | A | A |
| Example 1107 | | | | | A107 | 35 | A | A |
| Example 1108 | | | | | A108 | 35 | A | A |
| Example 1109 | | | | | A109 | 35 | A | A |
| Example 1110 | | | | | A110 | 35 | A | A |
| Example 1111 | | | | | A111 | 35 | A | A |
| Example 1112 | | | | | A112 | 35 | A | A |
| Example 1113 | | | | | A113 | 35 | A | A |
| Comparative Example 1101 | S0 | 1 | 0 | C | A101 | 35 | A | A |
| Comparative Example 1102 | | | | | A102 | 35 | A | A |
| Comparative Example 1103 | | | | | A103 | 35 | A | A |
| Comparative Example 1104 | | | | | A104 | 35 | A | A |
| Comparative Example 1105 | | | | | A105 | 35 | A | A |
| Comparative Example 1106 | | | | | A106 | 35 | A | A |
| Comparative Example 1107 | | | | | A107 | 35 | A | A |
| Comparative Example 1108 | | | | | A108 | 35 | A | A |
| Comparative Example 1109 | | | | | A109 | 35 | A | A |
| Comparative Example 1110 | | | | | A110 | 35 | A | A |
| Comparative Example 1111 | | | | | A111 | 35 | A | A |
| Comparative Example 1112 | | | | | A112 | 35 | A | A |
| Comparative Example 1113 | | | | | A113 | 35 | A | A |
| Comparative Example 2101 | S1 | 2 | 3 | A | B101 | 35 | A | C |
| Comparative Example 2102 | | | | | B102 | 35 | C | A |
| Comparative Example 2103 | | | | | B103 | 35 | C | B |
| Comparative Example 3301 | S0 | 1 | 0 | C | B101 | 35 | A | A |
| Comparative Example 3302 | | | | | B102 | 35 | A | A |
| Comparative Example 3303 | | | | | B103 | 35 | A | A |

As can be seen from the table, the image forming apparatuses of Examples, which use toners that satisfy the relations of the (ln η(T1)−ln η(T2))/(T1−T2) being −0.14 or less, the (ln η(T2)−ln η(T3))/(T2−T3) being −0.15 or more, and the (ln η(T2)−ln η(T3))/(T2−T3) being greater than the (ln η(T1)−ln η(T2))/(T1−T2), reduces leaking toner, color spots, and fog on the image in comparison with those of Comparative Examples, which use toners that fail to satisfy at least one of these relations.

1. An image forming apparatus comprising:
a photoreceptor;
a charging roller configured to charge a surface of the photoreceptor;
a light source configured to form an electrostatic charge image on the charged surface of the photoreceptor;
a developing device that includes:
a container containing an electrostatic charge image developer including toner and a carrier; and
a transporter configured to transport the electrostatic charge image developer,
wherein the transporter comprises:
a rotary shaft; and
a plurality of helical blades on an outer circumferential surface of the rotary shaft with a phase shift therebetween,
wherein the helical blades have a break zone, which is a zone in which the helical blades are discontinuous along an axis of the rotary shaft;
a transfer belt configured to transfer the toner image formed on the surface of the photoreceptor to a recording medium; and
a fixing roller configured to fix the toner image transferred to the recording medium,
wherein the toner satisfies the following relations:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3),
where η(T1) represents a viscosity of the toner at 60° C., η(T2) represents a viscosity of the toner at 90° C., and η(T3) represents a viscosity of the toner at 130° C.

2. The image forming apparatus according to claim 1, wherein the toner has a (ln η(T0)−ln η(T1))/(T0−T1), where η(T0) is a viscosity of the toner at T0=40° C., of −0.12 or more, and the (ln η(T0)−ln η(T1))/(T0−T1) is greater than the (ln η(T1)−ln η(T2))/(T1−T2).

3. The image forming apparatus according to claim 1, wherein the toner satisfies the following relation:
(ln η(T1)−ln η(T2))/(T1−T2)≤−0.16.

4. The image forming apparatus according to claim 1, wherein the toner satisfies the following relation:
(ln η(T2)−ln η(T3))/(T2−T3)≥−0.13.

5. The image forming apparatus according to claim 1, wherein:
the toner contains a release agent; and
the following relation is satisfied:
1.0<a/b<8.0,
where a and b are numbers of the release agent with an aspect ratio of 5 or more and smaller than 5, respectively, in the toner.

6. The image forming apparatus according to claim 1, wherein:
the toner contains a release agent; and
the following relation is satisfied:
1.0<c/d<4.0,
where c and d are areas of the release agent with an aspect ratio of 5 or more and smaller than 5, respectively, in the toner.

7. The image forming apparatus according to claim 1, wherein the toner has a highest-endothermic-peak temperature between 70° C. and 100° C.

8. The image forming apparatus according to claim 1, wherein the toner has a highest-endothermic-peak temperature between 75° C. and 95° C.

9. The image forming apparatus according to claim 1, wherein the toner contains a styrene-acrylic resin as a binder resin.

10. The image forming apparatus according to claim 1, wherein the toner contains an amorphous polyester resin as a binder resin.

11. The image forming apparatus according to claim 1, wherein the transporter has the helical blades on the outer circumferential surface of the rotary shaft in a substantially equally phased arrangement.

12. The image forming apparatus according to claim 1, wherein the transporter has the helical blades with two or more break zones.

13. The image forming apparatus according to claim 1, wherein the transporter has a radially projecting flat-plate paddle in the break zone.

14. The image forming apparatus according to claim 1,
wherein a percentage of an axial length of a section of the rotary shaft with the helical blades therearound relative to a whole axial length of the rotary shaft is 40% or more.

15. An image forming apparatus comprising:
a developing device that includes:
a container containing an electrostatic charge image developer including toner and a carrier; and
a transporter configured to transport the electrostatic charge image developer,
wherein the transporter comprises:
a rotary shaft; and
a plurality of helical blades on an outer circumferential surface of the rotary shaft with a phase shift therebetween,
wherein the helical blades have a break zone, which is a zone in which the helical blades are discontinuous along an axis of the rotary shaft;
wherein the toner satisfies the following relations:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3),
where η(T1) represents a viscosity of the toner at 60° C., η(T2) represents a viscosity of the toner at 90° C., and η(T3) represents a viscosity of the toner at 130° C.

16. An image forming apparatus comprising:
an image carrying means for carrying an image;
a charging means for charging a surface of the image carrying means;
an electrostatic charge image forming means for forming an electrostatic charge image on the charged surface of the image carrying means;
a developing means for developing comprising:
a container means for containing an electrostatic charge image developer including toner and a carrier; and
a transporter means for transporting the electrostatic charge image developer,
wherein the transporter means comprises:
a rotary shaft; and
a plurality of helical blades on an outer circumferential surface of the rotary shaft with a phase shift therebetween,
wherein the helical blades have a break zone, which is a zone in which the helical blades are discontinuous along an axis of the rotary shaft;
a transfer means for transferring the toner image formed on the surface of the image carrying means to a recording medium; and
a fixing means for fixing the toner image transferred to the recording medium,
wherein the toner satisfies the following relations:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3),
where η(T1) represents a viscosity of the toner at 60° C., η(T2) represents a viscosity of the toner at 90° C., and η(T3) represents a viscosity of the toner at 130° C.
